(19) United States
(12) Patent Application Publication
(10) Pub. No.: US 2013/0204739 A1
(43) Pub. Date: Aug. 8, 2013

(54) SYSTEM AND METHOD FOR GIFTING SUGGESTIONS AND PSYCHOGRAPHIC PROFILING

(71) Applicant: Morris Friedman, Encino, CA (US)

(72) Inventor: Morris Friedman, Encino, CA (US)

(21) Appl. No.: 13/831,944

(22) Filed: Mar. 15, 2013

Related U.S. Application Data
(63) Continuation-in-part of application No. 13/103,870, filed on May 9, 2011.
Application No. 13/103,870 is a continuation-in-part of application No. 12/544,183, filed on Aug. 19, 2009, now Pat. No. 8,280,825.
(60) Provisional application No. 61/636,949, filed on Apr. 23, 2012.
(60) Provisional application No. 61/234,965, filed on Aug. 18, 2009.
(60) Provisional application No. 61/090,608, filed on Aug. 20, 2008.

(51) Int. Cl. G06Q 30/06; G06F 3/0486

(52) U.S. Cl. CPC G06Q 30/0631; H04L 67/02; H04L 51/00; G06F 3/0486
USPC 705/26.7; 709/203; 709/206; 715/769; 715/780

(57) ABSTRACT

A computer-implemented method for electronic gift giving in which a gift suggestion is made, optionally based in part on a psychographic profile of a recipient. The method may be implemented by a website accessible on the Internet. A computer-implemented method is also described for generating a psychographic profile of an individual.

### CROSS-REFERENCE TO RELATED PATENT APPLICATIONS

This application claims priority to and the benefit of U.S. Provisional Patent Application No. 61/639,949, filed Apr. 23, 2012, and is a continuation-in-part of U.S. patent application Ser. No. 13/103,870, filed May 9, 2011, which is a continuation-in-part of U.S. patent application Ser. No. 12/544,183, filed on Aug. 19, 2009, now U.S. Pat. No. 8,280,825, which claims priority to and the benefit of U.S. Provisional Patent Application No. 61/090,608, filed on Aug. 20, 2008, and U.S. Provisional Patent Application No. 61/234,965, filed on Aug. 18, 2009, in the U.S. Patent and Trademark Office, the entire contents of which are incorporated herein by reference.

### FIELD OF THE INVENTION

The present invention relates to a method and system for making financial gifts, and more particularly to a method and system for making financial gifts associated with an electronic message and gift recommendations. Another aspect employs a method and system for psychographic profiling for various applications, including making gift suggestions

### BACKGROUND

The process of giving a gift can be stressful, time-consuming, and frustrating. A gift giver may experience stress as a result of attempting to determine an appropriate and desirable gift to present to the intended recipient, and the process of procuring the gift may require more time than the giver may reasonably devote to the process. For long distance giving, the giver often must travel to a post office or other shipping business, wait in line, and spend additional money beyond the cost of the gift to ensure the delivery of the gift to the recipient, which can be a stressful and time-consuming experience.

Further, the gift-giving experience may be frustrating for the giver and the recipient if the recipient is not pleased with the selected gift. In this situation, the giver will be frustrated because the investment of time and money in the gift-giving process did not yield the desired result of pleasing the recipient. Further, the recipient is frustrated, and possibly embarrassed, because the gift is not desired, and the recipient must either pretend to be pleased with the gift, or honestly report to the giver that the gift is unwanted so that the gift may be returned or exchanged for a more desirable item. This entails more wasted time, effort, and expense. Additionally, the earth's environment is negatively impacted as a result of producing and delivering the gift, which may be unwanted.

Conventional gift cards may not be a suitable solution to these problems. Giving conventional gift cards can feel impersonal because they are not customized or personalized for the particular recipient. Further, the gift card may still be physically shipped to the recipient, which takes additional time, negatively impacts the environment, includes the risk of fraud or being lost in shipment, and may require the recipient to shop at a particular store, which may also go out of business.

Accordingly, there is a need for a new method of gift giving that is personalized, efficient, environmentally friendly, and pleasing to both the giver and the recipient.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a flow chart illustrating an exemplary embodiment of a method for making financial gifts.

FIG. 2 is a flow chart illustrating a method by which an account is accessed according to another embodiment.

FIG. 3 is a flow chart illustrating a method by which a composition is created according to another embodiment.

FIG. 4 is a flow chart illustrating a method by which a gift value is determined according to another embodiment.

FIG. 5 is a flow chart illustrating a method by which the composition is edited according to another embodiment.

FIG. 6 is a flow chart illustrating a method by which purchase of the gift is completed according to another embodiment.

FIG. 7 is a flow chart illustrating a method by which notification of the gift is received and the composition is viewed according to another embodiment.

FIG. 8 is a flow chart illustrating a method by which a lockbox release request is processed according to another embodiment.

FIG. 9 is a flow chart illustrating a method by which the recipient receives the monetary gift according to another embodiment.

FIG. 10 is a block diagram depicting a system for making financial gifts according to an embodiment.

FIG. 11 is a block diagram depicting a system for creating a composition according to another embodiment.

FIG. 12 is a flow chart illustrating a method for making financial gifts according to another embodiment.

FIGS. 13A-13C illustrate features of an exemplary website application and method for electronic gifting.

FIG. 14A illustrates a diagrammatic flow diagram of an exemplary embodiment of a method for a gift giver to make a financial gift or suggestion according to the embodiment of FIGS. 13A-13C. FIG. 14B illustrates a diagrammatic flow diagram of an exemplary embodiment of a method for a gift receiver to receive a financial gift or suggestion sent by a gift giver. FIG. 14C depicts an exemplary home page of a website application implementing aspects of this embodiment. FIG. 14D is a diagrammatic depiction of a dashboard page of the website application. FIG. 14E illustrates an exemplary web page configured to prompt the gift giver to identify a recipient. FIG. 14F illustrates an exemplary web page prompting a gift giver to enter information regarding a recipient and illustrating gift suggestions from a recommendation engine. FIG. 14G illustrates an exemplary web page for arranging delivery details of a gift. FIG. 14H illustrates an exemplary web page for illustrating a clique feature of the web application. FIGS. 14I and 14J illustrate a computer-implemented system for providing gift suggestions. FIG. 14K illustrates an alternate embodiment of a web page for prompting a gift giver to enter information and select gift suggestions. FIGS. 14I-14S illustrate exemplary embodiments of web pages and web page features.

FIG. 15 shows a process flow diagram of an exemplary embodiment of a POP quiz process useful for the embodiments of FIGS. 13A-14K.

FIG. 16 illustrates a POP quiz question format for which the quiz taker provides a response in the form of a selection within a range.

FIG. 17 illustrates an example of a multiple choice, single answer POP quiz question.

FIG. 18 illustrates an example of a comparison “U&I” question/response format for a POP quiz.

FIG. 19 illustrates an example of a rank and rate POP quiz question format.

FIG. 20 illustrates an exemplary format of accumulation of point values earned by both the profiler and profilee and displayed simultaneously on the user's page at the website.

FIGS. 21-24 illustrate several examples of how the comparisons between a profiler and a profilee's responses may be organized and displayed. FIG. 21 illustrates how a comparison can be displayed for a range type of question. FIG. 22 shows a bar chart comparison for a multiple choice type of question. FIG. 23 shows a comparison for a comparison between the profiler and profilee (U & I).

FIG. 24 shows a graphical example of a comparison between the responses of profilers and the profilee for a rank and rate type of question.

FIG. 25 illustrates steps of an exemplary computer-implemented method for electronic gift giving.

FIG. 26 illustrates an exemplary computer-implemented method for generating a psychographic profile of an individual person to-be-profiled.

FIGS. 27A-27E diagrammatically illustrate features of an exemplary recommendation engine.

FIG. 28 diagrammatically illustrates feature of an exemplary address input feature useful for web applications.

### DETAILED DESCRIPTION

The detailed description set forth below in connection with the drawings is intended as a description of the presently preferred embodiments of a method and system for making financial gifts provided in accordance with the present invention and is not intended to represent the only forms in which the invention may be constructed or utilized. It is to be understood that the same or equivalent functions and structures may be accomplished by different embodiments that are also intended to be encompassed within the spirit and scope of the invention. As denoted elsewhere herein, like element numbers indicate like elements or features. Though steps of the method may be illustrated in one order, unless explicitly stated, the steps of the method of the present invention are not limited to any particular order and some of the steps may be optional.

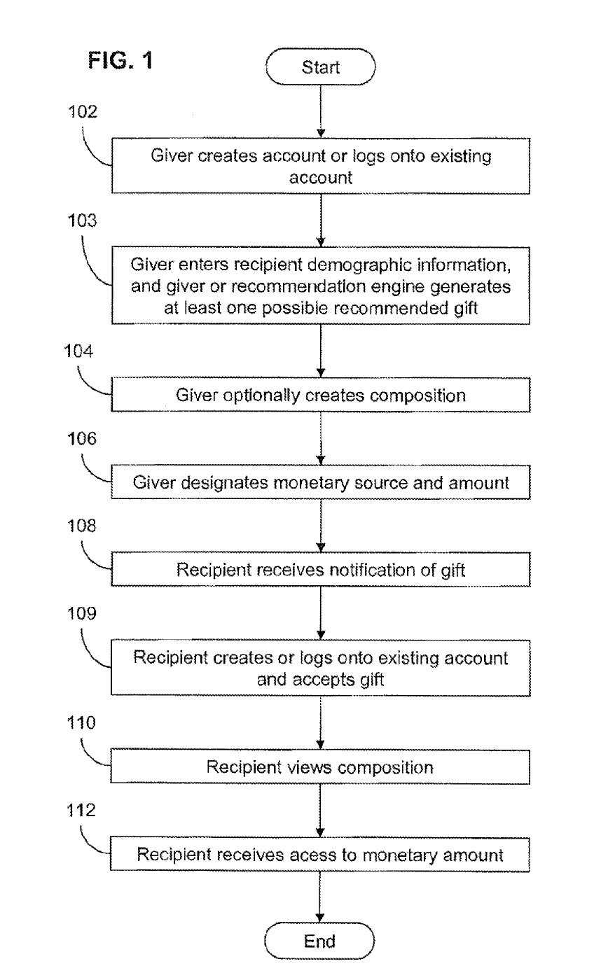

FIG. 1 depicts a method of making financial gifts according to an embodiment of the present invention. This method may be utilized by a giver who desires to give a gift that includes a monetary gift, at least one possible recommended gift or transfer of funds, and/or a composition representing a customized greeting display, which may be similar to an edited slide show or video presentation. The composition may create a virtual experience which the giver believes the recipient will enjoy and may suggest how the monetary gift might be utilized. This method provides a giver with an easy, convenient, and creative means of conveying a meaningful message, while also bestowing a cash gift that may be utilized in any way that the recipient chooses, including to purchase a recommended gift or transfer of funds to a charity or other third party. Also, this method benefits the environment by reducing or eliminating the manufacture, packaging, marketing, shipping, stocking, wrapping, and the resources necessary for delivery (and possibly return) of unwanted gifts to (by) the recipient, or the energy expended to shop for and deliver gifts even if they are well-received.

Further, an embodiment of the present invention provides entertainment for the giver. Here, the giver may experience fun and enjoyment during the process of customizing the display and/or selecting a recommended gift. The giver also has the opportunity to express his or her creatively during this process. Further, an embodiment of the present invention allows the giver to increase the value of the cash gift by including sponsored links and offers. Here, the value of the gift may be increased by the addition of coupons or rebates to the gift. In fact, providing sponsorship opportunities, with benefits offered to the giver and/or recipients, may occur at virtually any point in the process of the invention.

A giver creates an account or logs onto an existing account, step 102, to access the system. Next, the giver inputs recipient demographic information, and either the giver or a recommendation engine may generate at least one possible gift or transfer of funds, step 103. Here, the giver selects recommended gift(s) or transfer(s), and optionally creates a composition (or presentation), step 104, that may be customized for an intended recipient. The giver designates a monetary source and amount, step 106, to specify the value of the monetary gift and the account from which the transfer will proceed, such as a bank account or transaction card. Transaction cards may include, but are not limited to, debit cards, credit cards, smart cards, etc. Next, the recipient receives a notification of the gift, step 108, which also provides some method of accessing the gift. The recipient then creates or logs onto an existing account and accepts the gift, step 109. Finally, the recipient views the composition (or presentation), step 110, and receives the monetary gift, step 112, which may be held on account until used to make an online purchase, transferred to a check, a bank account, or a transaction card. At this time, accrued interest may also be transferred to the recipient.

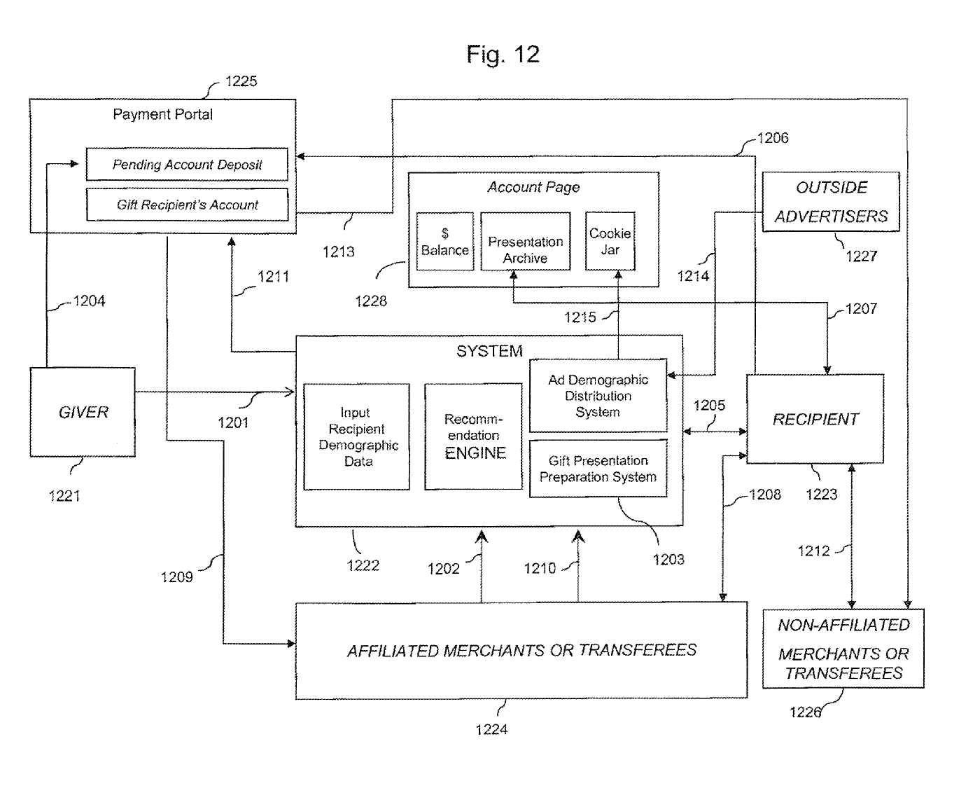

In another embodiment of the present invention shown in FIG. 12, the giver 1221 may choose at least one recommended gift or transfer of funds from a variety of possible recommended gifts or transfers provided to the giver 1221 possibly based on demographic information the giver 1221 enters about the recipient 1223. Thus, in addition to recommended purchases that the recipient might choose to make, the recommendations may also include potential charitable contributions or other transfers of funds. In any case, the giver 1221 initiates the gift and inputs recipient demographic data (if not already present) and the value of the monetary gift into the system 1222, where the data is stored, step 1201. For example, the giver 1221 may answer a questionnaire about the recipient 1223 including questions such as gender, age, hobbies, occupation, and possibly other similar attributes.

Catalog data, including available merchandise, is sent from affiliated merchants or transferees 1224 to the system, step 1202. The transferees may include any of a variety of entities, such as charities, financial institutions or other companies to which or through which the recipient of the monetary gift may want to transfer funds. Based on the recipient demographic data and the catalog data, a recommendation engine in the system 1222 creates a selection of possible recommended gifts or transfers for the giver 1221 to choose from, and the giver 1221 may choose one or more of the recommended gifts or transfers. For example, the recommendation engine may determine a list of possible recommended gifts or transfers of funds that the recipient 1223 is more likely to appreciate or enjoy based on the recipient demographic data. In another embodiment of the present invention, the giver 1221 has the option of self-selection of one or more of the recommendations.

A system 1203 for preparing a gift presentation provides one or more recommended presentation templates to the giver 1221, and the giver 1221 chooses a presentation template, step 1203. In an embodiment, the giver 1221 may be given the opportunity to customize or modify the presentation template or other aspects of the gift. The giver 1221 also transfers the monetary value of the gift to a payment portal provider 1225 (which may function in a manner similar to a virtual debit account), step 1204, where the value is a pending account deposit. In an embodiment of the present invention, the gift is returned to the giver 1221 if the recipient 1223 does not acknowledge the gift.

Next, a gift notification (which may be a notification email) is sent to a recipient 1223, step 1205, which includes the completed presentation template, the monetary value of the gift, and at least one recommended gift or transfer of funds chosen by the giver 1221. In an embodiment of the present invention, Internet links to on-line affiliates (affiliated vendors, merchants, or other entities) 1224 offering the recommended gift or transfer are also provided.

Once the recipient 1223 receives the gift notification, the recipient can either open an account or log onto an existing account. Once the recipient 1223 successfully logs in and verifies recipient identification information, step 1206, the recipient 1223 is directed to the presentation, and funds are transferred from a pending account deposit to a gift recipient's account at the payment portal provider 1225, which may be an affiliate financial institution. The recipient 1223 then views the presentation template, and at least one suggested gift or transfer link may appear (e.g., in a separate window), step 1207. Further, the recipient 1223 can then generate a thank you email, which may serve as an acknowledgement to the giver 1221.

From the presentation, the recipient 1223 can link to the recipient's account page 1228 to view the total available balance (and be informed of potential upcoming transfer fees, e.g., for expenditures with non-affiliated merchants or transferees 1226). The recipient 1223 may also review presentations stored in a presentation archive, click through to buy the suggested items or make the suggested transfers through online affiliated merchants, vendors, or other entities 1224, shop other items or other affiliated vendor sites, view other targeted advertiser offers 1227, or make any other payment or transfer of funds, such as a contribution to a charitable organization.

In an embodiment of the present invention, the accumulated, recommended gifts or transfers from all givers 1221 remain viewable and accessible on a “cookie jar” portion of the recipient's account page 1228 only while they are actually valid and available on the affiliate merchant's or transferee's website, and these recommendations are deleted when they are no longer available. In an embodiment, affiliated merchants may replace these gifts or transfers with current comparable items, deals, or opportunities, which may require that the affiliated transferee pay a fee. In other embodiments, the system 1222 may put new, ungifted recommendations on the cookie jar portion on behalf of outside paid advertisers who are targeting the people with the recipient's demographic data.

If the recipient 1223 selects an item to purchase or a transfer to make through an affiliated transferee 1224, step 1208, the recipient 1223 makes a purchase or transfer, similar to credit or debit card transactions, by entering a unique account number, and the cost of the item or amount of the transfer is transferred from the gift recipient's account by the payment portal provider 1225 to complete the purchase or transfer, step 1209. Affiliated merchants, vendors, or other transferees 1224 may then pay a commission or fee to the system 1222 based on the amount of the purchase or transfer, step 1210. If the balance of the recipient's account is less than the desired total amount of the purchase or the transfer, then the recipient 1223 may augment the balance of the recipient's account with funds from another source or the shortfall may be deducted from a prearranged, back-up source of funds.

In some embodiments of the present invention, an in-network transfer fee may be paid to the payment portal provider 1225, step 1211.

When the recipient 1223 chooses to shop at a non-affiliated vendor or transfer to a non-affiliated transferee 1226, step 1212, a nominal fee may be charged to the recipient 1223 for shopping non-affiliated vendors or transferring funds out of the affiliate network, and payment for the purchase or transfer would be made to the non-affiliated merchant or transferee from the payment portal, step 1213.

In embodiments of the present invention, outside advertisers 1227 may pay to have targeted advertisements and coupons appear on the system 1222 website, step 1214. The placement of these advertisements and coupons, step 1215, may be selected based on the recipient's demographic data, and the advertisements and coupons may be displayed when the recipient 1223 views the recipient's account page.

In other embodiments of the present invention, fees may be paid by the affiliate merchants or potential transferees for delivering anyone to their site (e.g., recommending merchandise of the affiliate), even if no further action is taken by the user. Further, affiliate merchants may pay a fee for having one of their products more highly recommended.

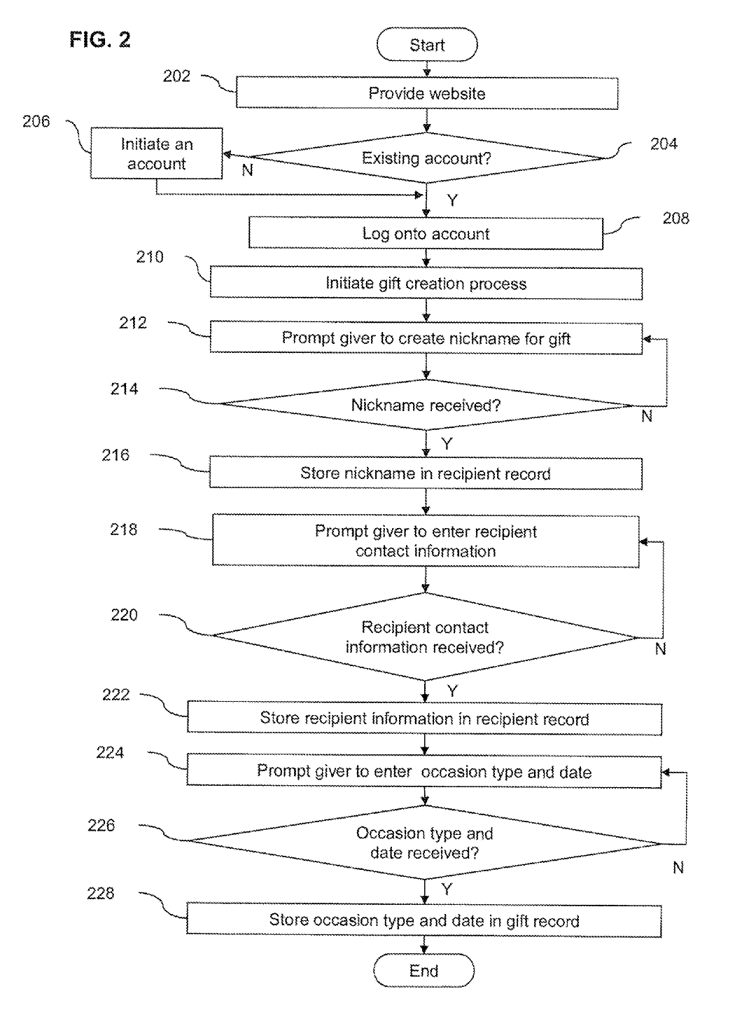

In another embodiment of the present invention, FIG. 2 depicts a method by which an account is accessed 102, as shown in FIG. 1. Here, the system provides a website 202, and a giver selects whether an account already exists 204 for the giver. If an account does not already exist, the giver is prompted to initiate an account 206. To initiate or create an account, the system prompts the giver to enter information, such as name, address, email address, phone numbers, etc. If an account already does exist, the giver is prompted to log onto the account 208. Once the giver has logged on to the account 208, the system initiates the gift creation process 210, and prompts the giver to create a nickname for the current gift 212, such as “Uncle Ernie's Retirement” or “Jimmy's 5th Birthday”. If no nickname is received, the system again prompts the user to create a nickname, or the system may assign a nickname based on the recipient information that is entered.

Once a nickname is received 214, the system stores it in a recipient record 216 in a recipient account database, and prompts the giver to enter recipient contact information 218, which may include recipient's name, physical address, email address, phone numbers, nickname, etc. The system may attempt to verify the recipient email address as active, and may prompt the giver to enter another email address if the initial email address is not active. If the recipient contact information is not received, the system again prompts the giver to enter it. Once the recipient contact information is received 220, the system stores it in the recipient record 222 in the recipient account database. The system prompts the giver to enter an occasion type and date 224. The occasion type may include categories such as birthday, wedding, graduation, just because, or a blank field. If the occasion type and date are not entered, the system again prompts the giver to enter it. Once the occasion type and date is received 226, the system stores it in the recipient record. The system may or may not charge a setup fee.

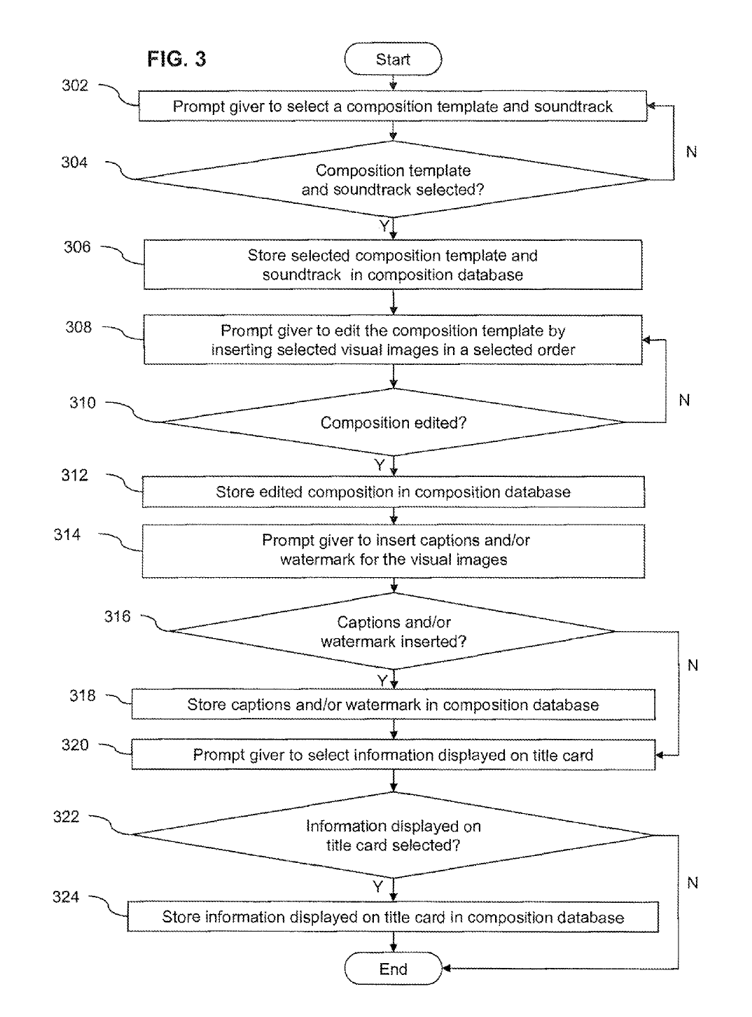

FIG. 3 depicts a flow chart illustrating a method by which a composition is created 104, as shown in FIG. 1, according to another embodiment of the present invention. Once the initial information is entered, the system prompts the giver to select a composition template from the composition template database and a soundtrack 302. Here, the composition template may be occasion specific (e.g., birthday, housewarming, or graduation), tailored to a recipient's interests (e.g., cats, baseball, or musicals), related to the type of purchase or transfer of funds the giver suggests the recipient to make with the gift (e.g., school tuition, dinner at a fancy restaurant, a spa experience, or a charitable donation), or may encompass other virtual experiences or types of themes, such as travel or education. The soundtrack may be chosen from a music library vendor, such as iTunes, which may require a separate fee, or it may be uploaded by the giver. Further, top picks of soundtracks used for the selected composition template may be displayed to help the giver to choose. If the composition template and the soundtrack are not selected, the system again prompts the giver to select them.

Once the composition template and soundtrack have been selected 304 and stored in the composition database 306, the system prompts the giver to edit the composition template by inserting visual images, such as selected pictures and/or video clips, in a desired order 308. The giver may also insert specific still images, other video, animation, computer generated images, transitions (which may be a sponsored advertising message which a sponsor purchases for a fee), title cards, graphic effects, and superimposed images. One method of editing the composition template may include graphically representing the soundtrack as a horizontal line. The giver may then select visual images to be dragged and dropped into a desired position along the horizontal line. Alternatively, the giver may select a pre-made composition.

In an embodiment of the present invention, the audio soundtrack may be selected from template-specific choices.

In an embodiment of the present invention, the audio soundtrack may be selected from a song sampling provided by outside vendors, which may have an associated fee. Also, the system may have propriety audio that may be utilized in the composition.

In an embodiment of the present invention, the giver may generate and/or upload an audio soundtrack and/or video components.

In an embodiment of the present invention, the giver may edit a template from a sponsor that provides audio and/or visual elements, which may include elements that are submitted by the sponsor.

In an embodiment of the present invention, a template is suggested to the giver based on demographic information entered by the giver.

Once the giver indicates that the composition has been edited 310, the system stores it in a composition database 312. Next, the system prompts the giver to optionally insert captions, including both text and audio captions, and/or a watermark for the visual images. If the giver optionally chooses to insert captions and/or a watermark for the visual images 316, the captions and/or watermarks are stored in the composition database 318. Additionally, the giver may be prompted to optionally select or enter information to be displayed on a title card at the beginning and/or end of the composition 320, which may include personalized information and greetings. If this information is entered 322, the system stores it in the composition database 324. Optionally, the information on the title card may be automatically chosen and inserted. Also optionally, the giver may choose to print out the composition or download the composition to a computer.

Optionally, the system may prompt the giver to preview or select coupon(s) to be inserted at the end of the composition. Here, special offers or discount coupons may be displayed for use at the end of the display of the composition. For example, coupons or offers may be chosen by the giver, based on the giver's understanding of the type of coupons or offers that may be desirable to the recipient. Alternatively, coupons or offers may be selected based on the template chosen by the giver, such as a cat magazine coupon for a template related to cats. Further, coupons or offers may be chosen based on the gift-giving occasion, may be chosen by the system based on recipient demographic information, or may be chosen randomly. Also optionally, the giver may be prompted to select whether or not coupons or offers will be displayed. Coupons that are displayed may be printed for future use, may have a internet link to a website for redemption, or may be redeemed by other methods.

In an embodiment of the present invention, the sponsor may be able to specifically market to a target audience because the marketing information, including coupons or offers, is presented to recipients based on the demographic information entered, which increases the likelihood that they will be interested in the particular good or service that the sponsor is offering. Further, the attention of the recipient is focused on the message of the sponsor because the recipient desires to determine what cash gift, as well as what sponsored offers, he or she has received, and the message appears to be endorsed by the giver. Additionally, the sponsor benefits from the website link or other sponsor information being available to the recipient, because the recipient may be more likely to purchase the goods or services of the sponsor.

In an embodiment of the present invention, the sponsor may be charged a set-up and/or per-click fee for the inclusion of the sponsors information with the composition.

In another embodiment of the present invention, the giver may optionally select to have transitions between pictures correspond to the beat of the music of the selected soundtrack. Here, the order of the pictures may be selected by the giver or the order may be placed in a random order by the system.

In another embodiment of the present invention, the giver may upload visual images from any source for inclusion in the composition.

In an embodiment of the present invention, the templates may be utilized with scenic environments that have regions for visual elements, selected by the giver or pre-chosen, to be displayed. For example, the visual elements may be displayed on gift boxes arranged under a Christmas tree.

In another embodiment of the present invention, the composition template provides a selection of components, motion clips, and drawing tools that allow the giver to perform a task virtually or display a virtual gift. The result may be similar to stop-motion animation. For example, a giver may construct a custom car, build a model of a sailing ship, design a baby outfit, arrange a bouquet, design a wedding gown, bake and decorate a cake, or draw a picture. In the example where a bouquet is arranged, the giver may select a vase to appear. Next, the giver may select individual flowers to be positioned in the vase in particular locations. Finally, the giver may decide to tie a ribbon around the vase. The composition may then display the vase, then each flower as it was selected, and then the ribbon, so that it appears that the flower arrangement is being arranged before the recipient.

In another embodiment of the present invention, the composition template provides one or more pictures that the giver may select for display in the form of a jigsaw puzzle. Here, any number of pictures may be utilized, but the process will be described with four pictures. The first picture is displayed on the jigsaw puzzle pieces. Optionally, a reference picture may also be displayed for the recipient to use as a reference to assemble the puzzle. The recipient begins to assemble the jigsaw puzzle. After one quarter of the jigsaw puzzle is assembled, the picture displayed on the puzzle pieces and the partially assembled jigsaw puzzle changes to a second picture. The recipient continues to assemble the jigsaw puzzle based on the second picture. After one half of the jigsaw puzzle has been assembled, the picture displayed on the puzzle pieces and the partially assembled jigsaw puzzle changes to a third picture. The recipient then continues to assemble the jigsaw puzzle based on the third picture. After three quarters of the jigsaw puzzle is assembled, the picture displayed on the puzzle pieces and the partially assembled jigsaw puzzle changes to a fourth and final picture. The recipient finishes assembling the jigsaw puzzle based on the fourth picture. When the recipient has completed the puzzle, the monetary gift is announced to the recipient. Further, there may be a fee associated with the puzzle.

In another embodiment of the present invention, the jigsaw puzzle composition template has a “cheat” button that causes the puzzle pieces to be placed, one by one, in the correct location when it is clicked. In another embodiment, the number of puzzle pieces can be related to the monetary value of the gift. For example, one puzzle piece might represent one dollar, so that a twenty piece puzzle has an associated monetary gift value of $20.

In an embodiment of the present invention, the gift may be a traditional e-card or a third party video game.

In another embodiment of the present invention, the gift may be a movie preview, cartoon, or film short.

In an embodiment of the present invention, the audio and/or visual elements may be purchased from a third party vendor by the giver.

In an embodiment of the present invention, sponsor coupons and/or offers may be related to a chosen template or to any of the options encountered in the preparation of a composition. For example, the template may display a customized fashion show of the current catalog of a sponsor that offers apparel and cosmetics. The related coupons and/or offer may include an internet link to the sponsor's website, free-samples of cosmetics, and nearest store directions. In another example, the template may display food items offered by a sponsor that is a restaurant. Further, the template may include scenes of a location, such as Paris, for a related restaurant, such as a French restaurant. For example, scenes of Italy, including gardens and harvests, may be shown for a pizzeria, along with scenes of pizza preparation and recipes. The related coupons and/or offers may include free dessert coupons, a link to a site to make reservations at the restaurant, and directions to the nearest location. In another example, a template that displays views of a golf course may have multiple sponsors, such as a golf course offering discounts at the starter's window or pro-shop and an equipment manufacturer offering discounts on golf balls.

In an embodiment of the present invention, a primary giver establishes a mailbox where content is compiled for the composition. For example, the audio soundtrack could include a conference call with selectable music tracks to facilitate, for example, family members singing happy birthday. In another example, video may be compiled from outside sources for assembly into a composition. In an embodiment of the present invention, a fee may be charged for this service.

In one particular embodiment of the invention, a giver identifies a registered recipient profile or enters recipient information to create a profile for an unregistered recipient. The system offers options to create a video composition, create a jigsaw puzzle, or create a craft. Next, the giver identifies how much money he or she wishes to send and what the occasion is. Here, the system offers options to reveal the gift amount to the recipient or keep the gift amount anonymous. Next, the system recommends possible composition templates based on the recipient's demographic information (e.g., age, occasion, and zip code), past templates used for the recipient, and/or preferences the recipient may have entered on a profile page. The giver then chooses a template from a full list of categories, such as sports, travel, museums, cooking, fashion, and kids. For example, if the giver chooses sports templates, a sports menu is displayed with categories, such as baseball, football, basketball, car racing, and Olympics. Here, if the giver chooses baseball, a baseball menu is displayed, which may include teams, players, all-star games, world series, and Hall of Fame players. If the giver chooses teams from this menu, a list of baseball teams is displayed. If the giver chooses a particular team, a menu for that team is displayed, which may include players, all star games, world series, and Hall of Famers. If the giver chooses players, a players menu is displayed, which may include a list of all players (sponsored by a first sponsor), hall of famers (sponsored by a second sponsor), particularly famous players (each of which may be sponsored by a sponsor), or the option to build an “All Time Greats Team.”

In the current example, if the giver chooses a particularly famous player, the system provides the option of making a composition or selecting from a collection of pre-made compositions. If the giver chooses to make a composition of his or her own, the system provides one clip or picture of the famous player for each dollar being gifted to the recipient. Alternatively, the system randomly fills a changeable matrix of clips, each of which has a specific dollar value attached or pictures of the famous player. Next, the giver selects an audio track from a recommended list (e.g., which may include the five most popular tracks), or the giver may choose a different soundtrack so that the system performs an on-line search of music sites and offers results including source location and cost. Further, the giver may select a personal download, where the options provided include creating a personal recording (which may require a fee and require the giver to call a telephone number and enter a code), or create a group conference call with background music (which may require a fee and require a telephone call using a code). Here, for example, the personal recording file may be retained for a specified period, e.g., 48 hours, in the system pending group recording completion, and allow the giver to sign back into the system and select a pending gift from a user profile page to continue creation of the gift.

Further in the current example, the giver completes the soundtrack and continues by selecting clips or pictures from a dollar value matrix and places them in order on a horizontal editing bar. The system may place transition graphics, which may be sponsored, between scenes. The giver may then select sound effects and place them where desired on the editing bars, e.g., a medium crowd roar, a maximum crowd roar, the crack of a bat, a “holy cow” soundbite, and/or a “get yer peanuts” soundbite. The system may also offer options to re-randomize the dollar amount matrix (e.g., for a certain value per “lever pull”) or purchase additional pictures or clips (e.g., fees might be 5 visual images for 25 cents, 12 visual images for 50 cents, or 30 visual images for a dollar). Once the giver completes the clips or pictures and sound selection, the system offers opening and closing title card options, which the giver completes. The system may further offer editing options of edit to time and edit to music, and the system executes this decision and previews the composition. Here, the giver may re-edit the composition, or the giver approves the composition and the system may offer or automatically apply sub-sponsor coupon options. The system then offers a rounding out gift dollar amount options (e.g., −10% or +100%), a lockbox option, and/or delivery options, such as create a gift wrap for the gift (where a demonstration may be viewed and/or a fee may be charged which may be donated to an environmentally focused organization) or present composition in a scenic environment option, such as a birthday, wedding, holiday, or a certain location (where a demonstration may be viewed and/or a fee may be charged which may be donated to a charitable organization). Finally, the system requests delivery date and time.

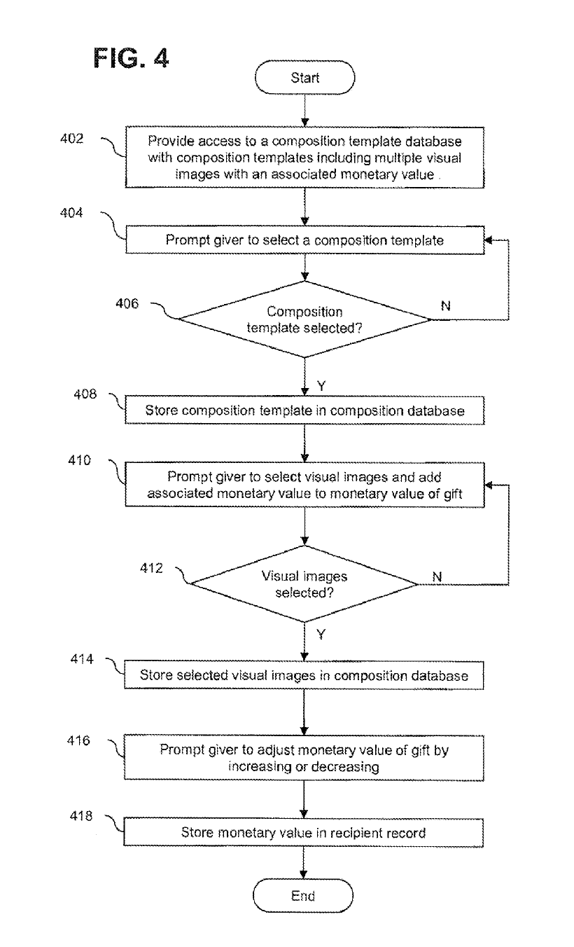

FIG. 4 depicts a flow chart illustrating an optional method by which a gift value is determined 106, as shown in FIG. 1, according to another embodiment of the present invention. This denomination matrix method provides an entertainment aspect to the creation of the composition by the giver. Here, the system provides the giver access to a composition template database including composition templates with multiple visual images with an associated monetary value 402, such as $1 for pictures in group 1, $5 for pictures in group 2, and $10 for pictures in group 3. Next, the system prompts the giver to select a composition template 404. If a composition template is not selected, the system again prompts the giver to select a composition template. Once the composition template is selected 406, the system stores it in the composition database 408. Next, the system prompts the giver to select visual images, and the associated monetary value is added to the monetary value of the gift 410. Once the giver indicates that the visual images have been selected 412 and the desired amount has been reached, the system stores them in the composition database 414. For example, the giver wants to send her niece $26 for her 26th birthday. She would select one picture from group 1, one picture from group 2, and two pictures from group 3 for a total monetary value of the gift of $26.

In another embodiment, by overlaying a randomizer, the giver may spin a slot machine of visual images to select the visual images that will be displayed. Here, elements of fun and chance are added to the giver's experience in creating the gift. Further, this embodiment may also allow the giver the opportunity to obtain specifically desired visual images at a reduced cost or for free. Also, the giver may be charged a fee for each spin.

However, in another embodiment of the present invention, the system prompts the giver to adjust the monetary value of the gift by increasing or decreasing the monetary value 416. For example, the giver may decide to give her niece an additional $100. Therefore, the giver may add $100 to the $26 already included in the monetary value of the gift for a total of $126. The system stores the adjusted monetary value in the recipient record 418 in the recipient account database.

In another embodiment of the present invention, the visual images may be a certain value (e.g., $1) per visual image, the total value of which will be the total value of the monetary gift. In another embodiment of the present invention, the visual images may be purchased for a lesser (e.g., wholesale) amount (e.g., 25 cents each or 5 visual images for a dollar).

In another embodiment of the present invention, composition templates may be offered with no monetary value associated with the visual images. Here, the system may prompt the giver to pay a setup fee to send the composition. However, the giver may also enter a monetary value for a gift.

In another embodiment of the present invention, if the giver uploads visual images from another source for inclusion in the composition, the giver selects and enters a monetary value for a gift. Further, there may be a fee for importing visual images.

In another embodiment of the invention, the giver may designate that the monetary gift be deposited in an anonymous pool, so that the recipient is not notified of the precise amount of the monetary gift. Here, after viewing the composition, a message would inform the recipient that the monetary gift is in an anonymous pool, where the amount remains anonymous and earns interest until an event occurs, such as: a certain number (e.g., six) of deposits have been made into the anonymous pool; the total balance of the anonymous pool exceeds a certain value (e.g., $150); or a certain time period has passed since the first deposit was made into the anonymous pool (e.g., six months). Once one of these conditions has been met, the total balance of the anonymous pool is revealed to the recipient. The anonymous pool may be utilized for pooled gifts, such as office retirement parties or baby showers. For example, one or more givers or the recipient may establish an anonymous pool, such as an event-specific anonymous pool, and invite other givers to contribute to the pool. In another embodiment, the giver can establish a predetermined, near-term date at which the anonymous pool funds would become available to the recipient, such as the actual date of retirement or the date the co-worker's baby is born.

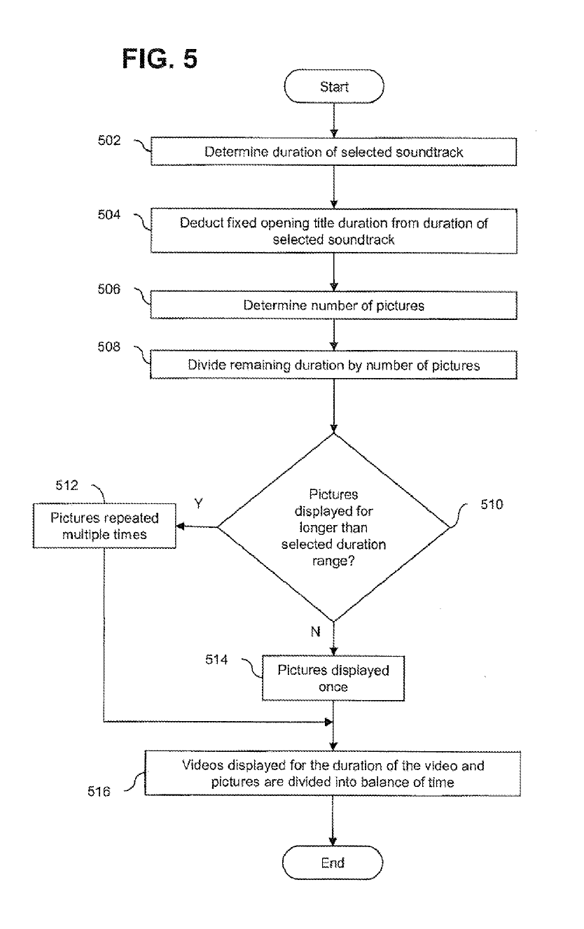

FIG. 5 depicts a flow chart illustrating a method by which the composition is edited according to another embodiment of the present invention. Here, the system determines the duration of the selected soundtrack 502. For example, the duration of the selected soundtrack may be 206 seconds. Next, the system deducts a fixed opening title duration from the duration of the selected soundtrack 504. For example, a fixed opening title duration of 10 seconds may be deducted so that the remaining duration is 196 seconds. The system then determines the number of pictures 506 selected (e.g., 10) and divides the remaining duration by the number of pictures 508. In the above example, this results in a duration of 19.6 seconds for each picture.

In one embodiment of the invention, the system may be instructed to allow a minimum and maximum selected duration for each picture. For example, a duration range may be between 5 seconds and 10 seconds. In this embodiment, the system determines whether pictures are displayed for a selected duration range 510. If the pictures are displayed for a duration longer than the selected duration range, the pictures (or picture sequence) are repeated multiple times 512. If the pictures are displayed for a duration within the selected duration range, the pictures are displayed once 514. In the example above, the duration of each picture, 19.6 seconds, is greater than the selected duration range between 5 seconds and 10 second. Therefore, the pictures (or picture sequence) will be repeated a second time so that the duration of each picture is 9.8 seconds, which is within the selected duration range. Here, videos are displayed for the duration of the video, though video duration may be adjusted with time compression and/or expansion techniques, and the pictures are divided into the balance of time 516.

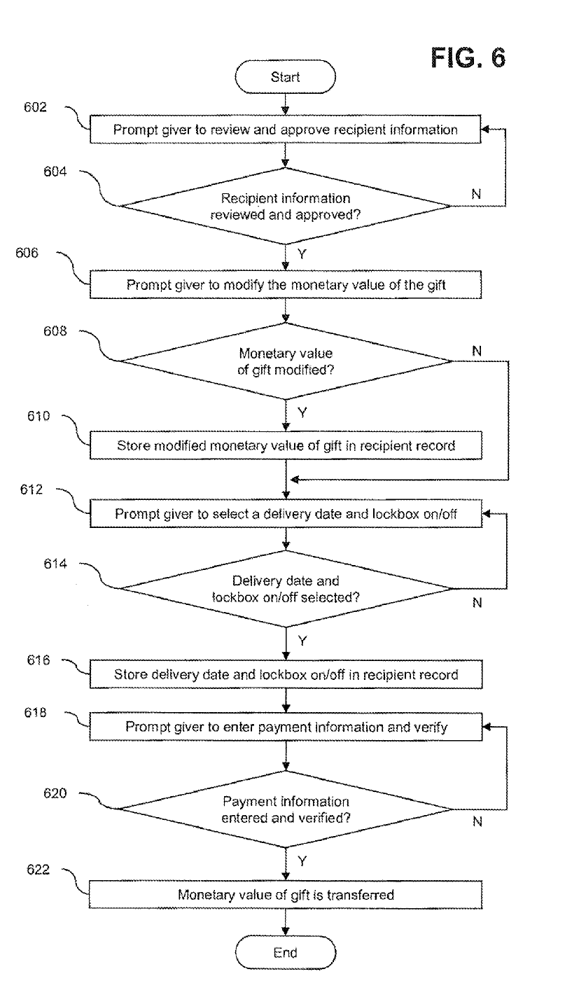

FIG. 6 depicts a flow chart illustrating a method by which a purchase of the gift is completed by the giver designating a monetary source and amount 106, as shown in FIG. 1, according to another embodiment of the present invention. Here, the system may prompt the giver to review and approve recipient information 602 for accuracy prior to actually sending the gift. Once the giver indicates that the recipient information has been reviewed and approved 604, the system may prompt the giver to optionally modify the monetary value of the gift 606, which may be increased or decreased. If the monetary value of the gift is modified 608, the modified monetary value of the gift is stored in the recipient record 610 in the recipient account database.

The system may also prompt the giver to select a delivery date for a notification, such as email, to be delivered, and whether to turn on a lockbox feature 612. The lockbox feature is designed to encourage savings by allowing the giver to restrict access to the monetary value of the gift until some time in the future. When selecting the lockbox feature, the giver may select a specific date to provide access to the monetary value of the gift, or select a specific time period that must pass before providing access to the monetary value of the gift. If the delivery date and lockbox on/off are not selected, the system again prompts the giver to enter this information. Once the delivery date and lockbox on/off are selected 614, they are stored in the recipient record 616 in the recipient account database.

Also, the giver will be prompted to enter and verify payment information 618, such as transaction card or bank account information for an electronic funds transfer, to pay any setup fees and to transfer the monetary value of the gift. Once the payment information is entered and verified 620, the transaction is completed after acceptance by the giver by the system transferring the monetary value of the gift 622 to a system account and an account balance in the recipient record is modified to reflect the additional monetary value. Optionally, the recipient may be able to reject the gift, and the giver will then receive a refund. Further, set-up and transfer fees may occur in the same transaction or in a different transaction.

In another embodiment of the present invention, the payment information, such as transaction card or bank account information for electronic funds transfer, will be authorized prior to selection of a composition template.

In another embodiment of the present invention, interest accumulates in the recipient account based on the monetary value of the gift and a gift interest rate. For example, if the giver completes the creation and purchase of the gift with a monetary value (e.g., $100) a period of time before the actual delivery date of the gift (e.g., 3 months) and the gift interest rate is 2% per 3 months, interest (e.g., $2) will be added to the monetary value of the gift. In another embodiment, if the recipient does not withdraw the gift, the gift will continue to earn interest until it is withdrawn or returned. Here, interest may not be paid to the recipient until the gift is accepted. However, interest may not be paid if the gift is not accepted.

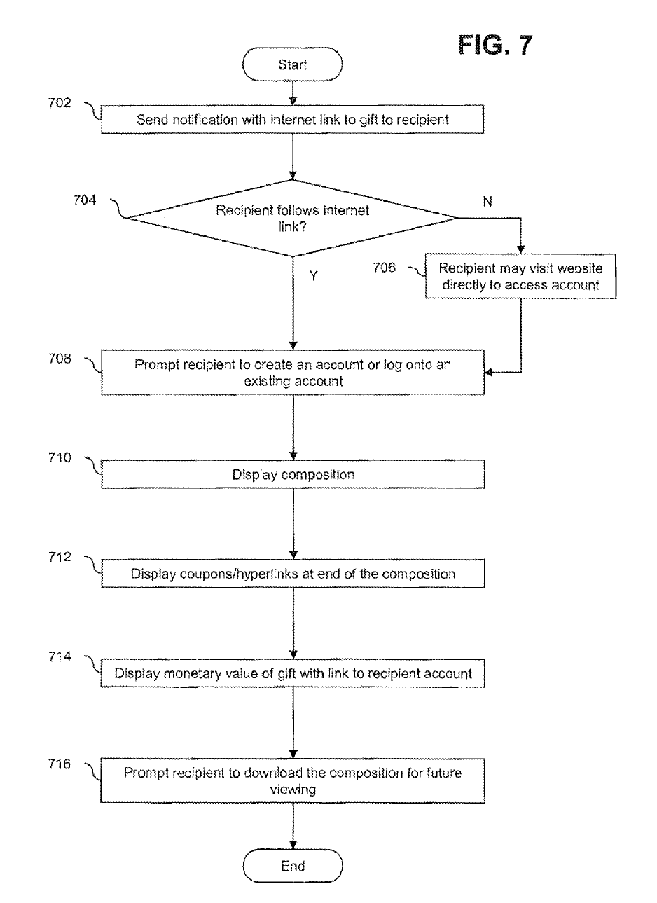

FIG. 7 depicts a method by which notification of the gift is received 108 and the composition is viewed 110, as shown in FIG. 1, according to another embodiment of the present invention. Here, a notification, such as an email, with an internet link to the gift is sent to the recipient 702, which may or may not provide the name of the giver in the body of the email or in the subject line of the email. However, the notification will contain information regarding how to view the gift, which may include an internet link to a website where the gift may be viewed or a website address that may be accessed to view the gift, if the recipient does not follow the internet link in the notification. At the website, the recipient may search for a gift, which may be useful if the recipient inadvertently lost or deleted the notification. If the gift is not viewed, follow-up notifications may be sent, e.g., sent daily for a month. If no response from the recipient is received after a specified time period, the monetary value of the gift may be returned to the recipient.

If the recipient does follow the link in the notification 704 or visit the website 706 to begin the process to access the gift, the system will prompt the recipient to create an account or log onto an existing account 708, which may include selecting and/or entering a user name and password and confirming the information entered by the giver. The system will display the composition 710, and the recipient may control features of the display, such as volume, pause/play, and on/off captions. The system may optionally display coupons/hyperlinks along with the composition 712. Further, the system will display the monetary value of the gift with a link to a recipient account 714. The system may also prompt the recipient to optionally download the composition for future viewing 716 or print a printable version of the composition. The recipient may also optionally send an automatic “thank you” email to the giver that may be personalized.

In another embodiment, the composition may only be available for download for a certain period, for example, 48 hours. Optionally, a copy of the composition may also be delivered to the giver, either when the recipient views the composition or downloads the composition.

In another embodiment of the present invention, recipients may establish a profile page and enter a number of wish-list items (e.g., four) or potential transfers of funds on their profile page, which givers may suggest that the recipient obtain using the monetary gift (e.g., an earmark).

In an embodiment of the present invention, the giver may virtually wrap the present, which may be free or may have a fee. For example, the giver may select a box shape, paper, ribbon, bow(s), and/or other extras (e.g., a flower or a baby rattle) to virtually wrap the gift. The recipient may find points on the displayed gift to click so that some of the wrapping unrolls, rips off, crumples, turns into confetti, gets bitten off, and/or is removed in other ways. Here, the enjoyment and anticipation of unwrapping a real gift is replicated. In an embodiment of the present invention, a cheat button will reveal the next point to click.

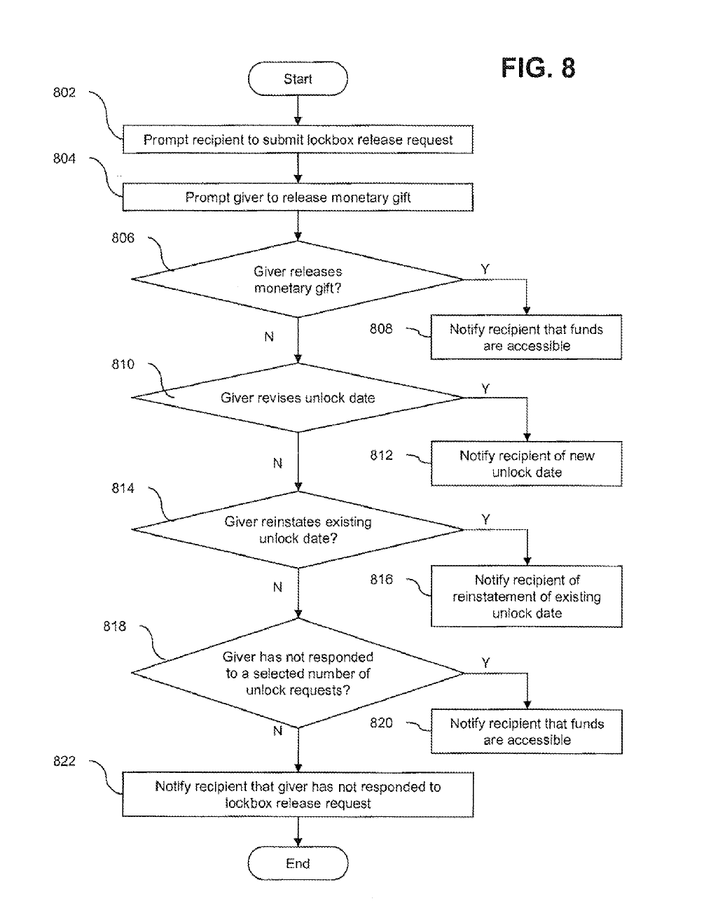

FIG. 8 depicts a flow chart illustrating a method by which a lockbox release request is processed according to another embodiment of the present invention. Here, the system will prompt the recipient to submit a lockbox release request once per given time period 802. For example, a lockbox release request may be submitted once per three months. The system may prompt the giver via email to decide whether to release the monetary gift 804. The giver may respond to the request in one of three methods. First, the giver may release the monetary gift 806, and the recipient may be notified that the funds are accessible 808. Second, the giver may revise the unlock date 810 by either moving the unlock date sooner or later, and the recipient may be notified of the new unlock date 812. Third, the giver may reinstate the existing unlock date 814, and the recipient may be notified of the reinstatement of the existing unlock date 816. If the giver has not responded to a selected number of unlock requests 818 (e.g., three unlock requests), then the funds are released and the recipient may be notified that the funds are accessible 820. If the number of unlock requests is less than a selected number and the giver has not responded, then the recipient is notified that the giver has not responded to the lockbox release request 822.

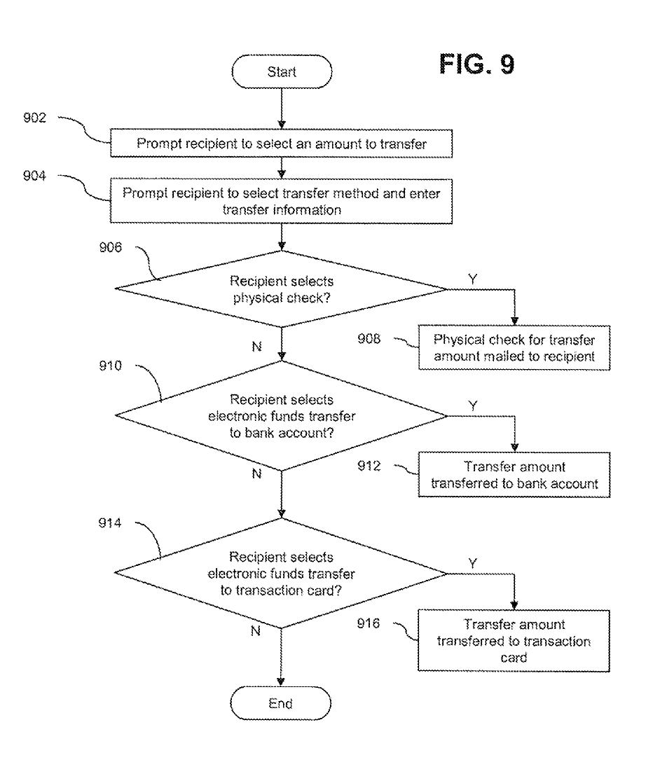

FIG. 9 depicts a method by which the recipient receives the monetary gift 112, as shown in FIG. 1, according to another embodiment of the present invention. Here, the system prompts the recipient to select an amount to transfer 902. The system prompts the recipient to select a transfer method and enter transfer information 904. If the recipient selects a physical check 906, then a physical check for the transfer amount is mailed to the recipient 908. Here, the system prompts the recipient to enter a physical mailing address. If the recipient selects an electronic funds transfer to a bank account 910, then the transfer amount is transferred to the bank account 912, which may incur a fee. For example, the recipient enters bank account information, such as the name on the account and routing information. If the recipient selects electronic funds transfer to a transaction card 914, then the transfer amount is transferred to the transaction card 916. Here, the recipient enters transaction card account information, such as the name on the account and the account number. Optionally, the recipient may “re-gift” the monetary value of the gift by applying the monetary value of the gift to another gift for another recipient.

In another embodiment of the present invention, a recipient may receive a monetary gift by designating that the monetary gift be transferred to a non-interest bearing account. A record of the composition and monetary gift may be then saved in an archive record. Once the monetary gift has been transferred, it may then be transferred to a bank account or a transaction card, a physical check, or any combination of thereof. The funds may also be used for direct re-gifting, meaning that they can be applied to the creation of another composition and monetary gift for another recipient.

In another embodiment of the present invention, recipients may designate an alternate recipient in the event of the recipient's death. The recipient may also designate that the monetary value be transferred to the alternate recipient at a certain date, which may be after the death of the recipient.

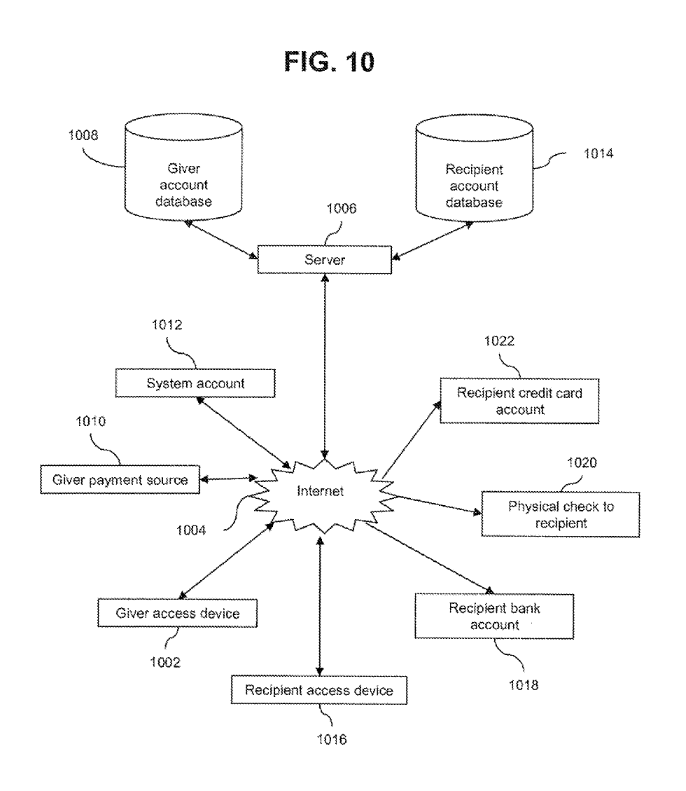

FIG. 10 depicts a system of making financial gifts according to an embodiment of the present invention. The system may include a giver access device 1002 that provides a giver with a link through the internet 1004 to a server 1006 linked to a giver account database 1008. The server 1006 is configured by hardware and/or software to execute the methods illustrated in FIGS. 2 and 6-9.

The giver enters a monetary value of a gift and billing information through the giver access device 1002, which is stored in a giver record in the giver account database 1008. Once the transaction is completed, the monetary value of the gift is transferred from the giver payment source 1010 to the system account 1012 through the internet 1004, and the value is recorded in a recipient record in the recipient account database 1014 that is linked to the internet 1004 through the server 1006. A recipient may access the recipient record in the recipient account database 1014 through a recipient access device 1016 that is linked to the internet 1004 to view the monetary value of the gift. The recipient may request a monetary transfer from the system account 1012 to either a recipient bank account 1018, a physical check to the recipient 1020, or a recipient transaction card account 1022.

Optionally, the recipient may archive or store information from the recipient record in the recipient account database 1014, such as the giver, the date, the occasion, and the monetary value for later reference.

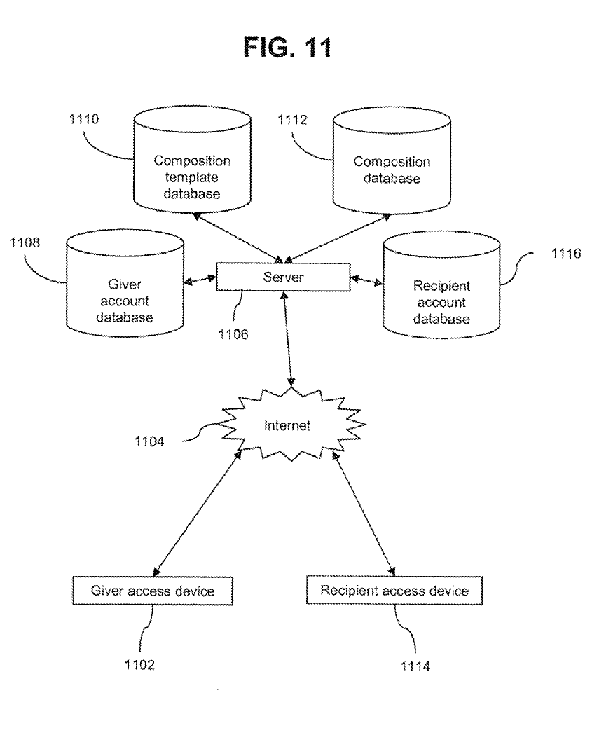

FIG. 11 depicts a system of creating a composition according to an embodiment of the present invention. The system may include a giver access device 1102 that provides a giver with a link through the internet 1104 to a server 1106 linked to a giver account database 1108 and a composition template database 1110. The server 1106 is configured by hardware and/or software to execute the methods illustrated in FIGS. 2-5 and 7.

The giver may select a composition template from the composition template database 1110, edit the composition template to create a composition, and store the composition in a composition database 1112, also linked to the server 1106. The system may also include a recipient access device 1114 that provides a recipient with a link through the internet 1104 to the server 1106 that is linked to a recipient account database 1116 to view a list of compositions and the composition database 1112 to view and/or download the composition.

In another embodiment, interest is compounded and paid quarterly, and partial quarterly interest is not paid on funds withdrawn between quarters.

In another embodiment, composition template pictures may be obtained from and/or sponsored by third parties, such as magazines or film studios.

In another embodiment, virtual shopping spree or fashion show composition templates can be obtained from and/or sponsored by retailers, and links may be provided to their websites.

In another embodiment, sponsored restaurant menus, themed picture, such as pictures of food items or Australia for an outback-type restaurant, and recipes can provide virtual dining experiences.

In another embodiment, sponsors can compete and/or bid for the right to sponsor templates or other aspects of the present invention.

In another embodiment, marketing research data may be derived from the activities of both recipients and givers, and this data may be sold to sponsors or provided with sponsorship.

In another embodiment, content for the composition may be derived from sources, such as social networking internet sites or internet sites that provide a forum to post video and/or audio content.

Insofar as is known to applicant, no presently known gifting website or affiliate marketing publisher makes its products or service recommendations by aggregating the profile input about an individual recipient from all respondents, including possibly the recipient, in which the profile includes psychological and demographical profile input, not just the product specificity of a wish list. Further, no presently known website then allows the giver to share a number of the product or service recommendations with the recipient while actually only transferring cash over the Internet, which the recipient can use to purchase suggestions, or other items from affiliated vendors, or to transfer to an independent financial service such as a bank or credit card account for an alternative use. In accordance with a further exemplary embodiment and aspect of the invention, the foregoing methodology is sometimes referred to herein as “iftGift,” a coined term. IftGift may refer to a website application set up and running on a server connected to the Internet, which implements the methodology. In an exemplary iftGift embodiment, the only gift actually delivered to a recipient is funds delivered over the Internet, and deposited into the recipient's personal iftGift account. The gift giver readily selects and sends several gift suggestions from the computer-generated list of suggestions derived from the recipient's profile, or in some embodiments may also search for and make suggestions independently from items available through the website's affiliates. The profile may result from the answers to questions input by the gift giver, as well as the recipient's network of family and friends, and/or from analyses of previous suggestions and/or purchases made by and for the recipient, the recipient's network of family and friends and/or other recipients who share the recipient's demographic and/or psychographic profile, so that the suggestions are appropriate to the recipient.

In accordance with a further embodiment, in what applicant refers to sometimes herein a personal opinion profile (POP) quiz process or “iftPut Q&A” feature, a computer system (e.g. a server connected to the Internet which hosts an application accessible via the web and/or other platform, such as a mobile or tablet device) is programmed to pose a series of questions to a respondent about a particular individual. The questions are, for example, physically descriptive, psychographic and/or demographic in nature. As used herein, “psychographic” factors or variables refer to personality, values, attitudes, behavioral characteristics, interests, cultural and lifestyle factors or variables. As used herein, “demographic” factors or variables refer to objective information including a person's age, sex and geographic location. The POP quiz process calls for respondents (users as well as potential gift givers or profilers) to enter their subjective assessment of what the appropriate answer(s) to a question is relative to the subject individual ((potential) gift recipients or profilee). These answers are then compiled with answers provided by everyone who has elected to answer the specific question either about the subject individual or others. The POP quiz questions and answers can be part of a gift preparation process, or independent of a gift preparation process. The questions may be presented in any of numerous formats, for example, range, multiple choice, comparison between the profiler and profilee, or weighted ranking and rating of numerous variables and the frequency or priority of their use or preference. By way of example, and as described more fully below, a first format could provide continuums on a range and the respondent would identify where on this continuum the subject individual would fall; for example: neat—slovenly; fat—skinny; generous—frugal; rich—poor.

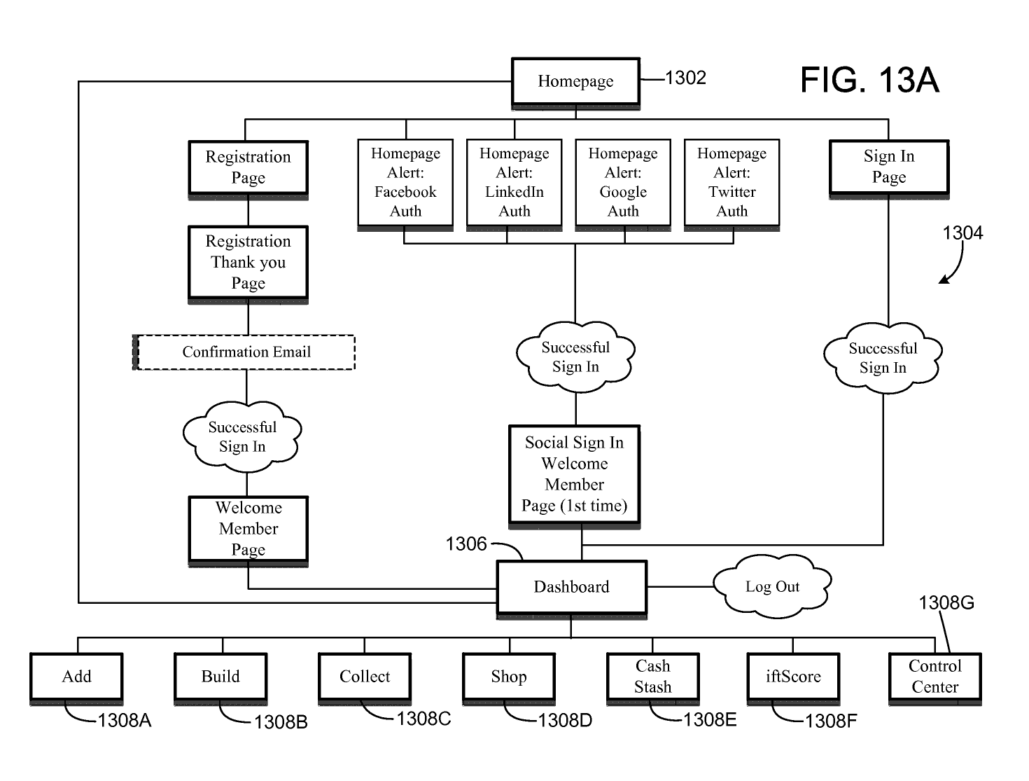

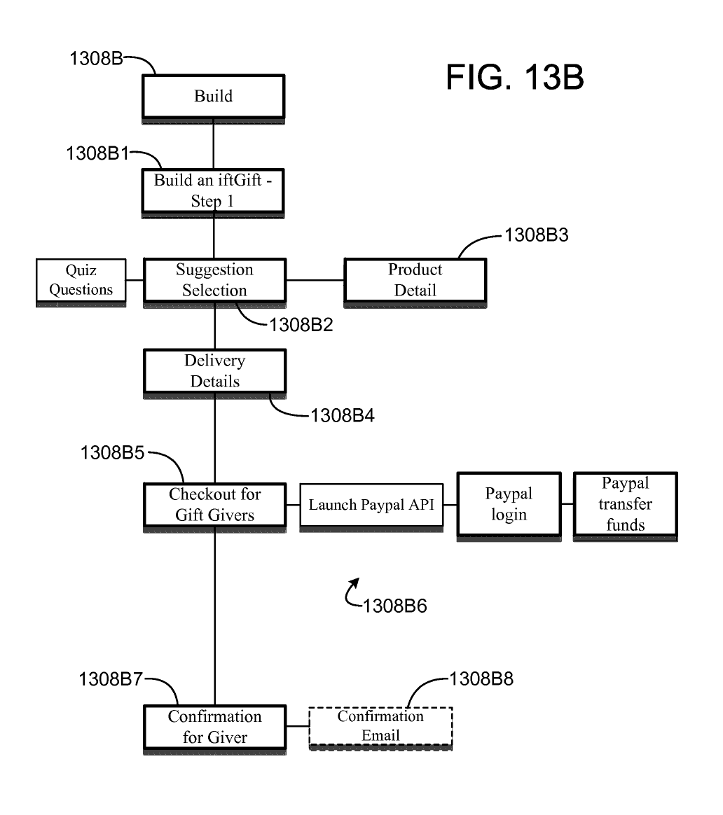

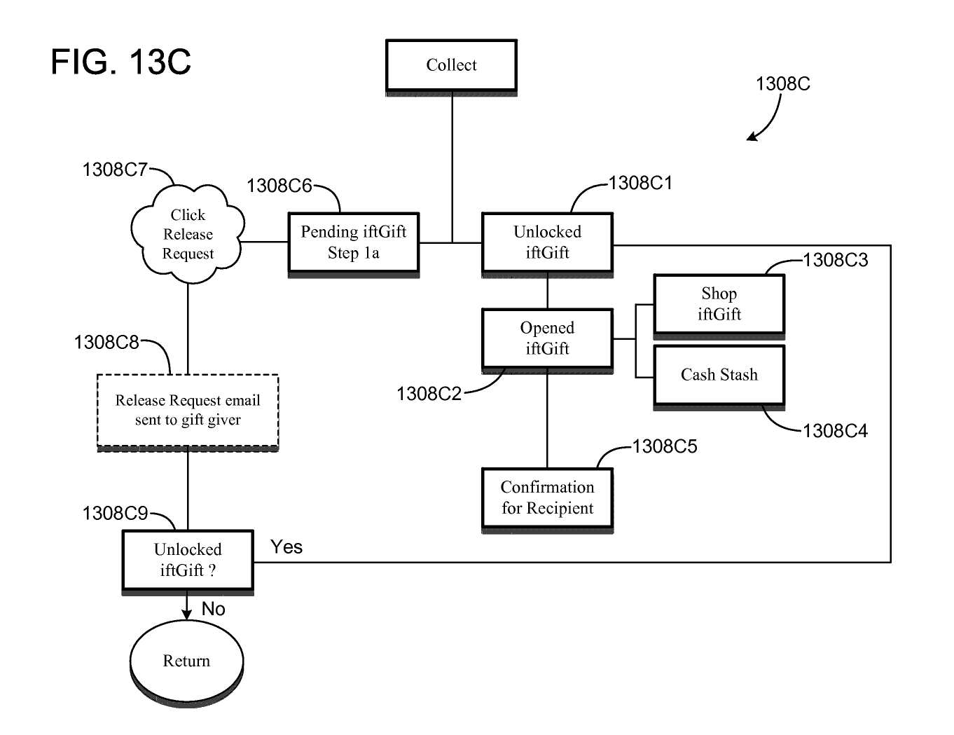

FIGS. 13A-13C illustrate features of an exemplary website application and method for electronic gifting. A user navigates to the website home page at 1302, and either logs in as an existing member or registers as a new member at 1304. Login as an existing member can be by a sign-in page with user name and password, or through social media sites. Once login or registration has occurred, the website application directs the user to a dashboard page (1306). The dashboard page presents the user with several choices of functions or activities, which may be accessed from the dashboard page. These functions include add data (1308A), build a gift (1308B), collect a gift (1308C), shop (1308D), review a cash balance or “cash stash” (1308E), view an existing member score or points balance (1308F), and a control center page (1308G).

FIG. 13B is a flow diagram illustrating general features of an exemplary process for building gift suggestions and sending a financial gift, from the “build” page 1308B of the website (FIG. 13A). At an initial step 1308B1, the gift recipient is identified, along with the cash value of the gift. At 1308B3, a suggestion selection process takes place, and can include answering questions designed to elicit psychographic data about the recipient, as will be described more fully below. Alternatively, the gift giver may elect to use existing data regarding the recipient already stored by the system, in order to generate gift suggestions, at 1308B3. The gift suggestions and cash gift are then processed to set up the delivery to the recipient at 1308B4, and a checkout process 1308B5 occurs, wherein a funds transfer service (such as PayPal™) is invoked to transfer the gift funds to the recipient, provided there is no lockbox delay associated with the gift. A confirmation message 1308B7 is prepared and then can be sent to the recipient, e.g. by email or text message (1308B8).

FIG. 13C illustrates an exemplary process flow for a gift recipient to collect a gift (1308C, FIG. 13A). If the gift is unlocked (1308C1), and thus available for immediate collection, it is opened (at 1308C2), and the recipient can either shop (1308C3) using the suggestions if desired or more generally using the cash account or stash (1308C4). The system may then provide a confirmation for the recipient of the action taken (1308C5). If the gift is locked (for access at a time in the future), the recipient may choose to request the gift giver to release the gift earlier (1308C7 and 1308C8). The release request process is not instantaneous, and may proceed over time, through a series of back and forth emails channeled through the site between the recipient and gift giver, leading to the notification of whether the gift has been unlocked or the new release date. Once the gift giver has unlocked the gift (1308C9), the recipient can login again, and proceed to 1308C1 to collect the gift.

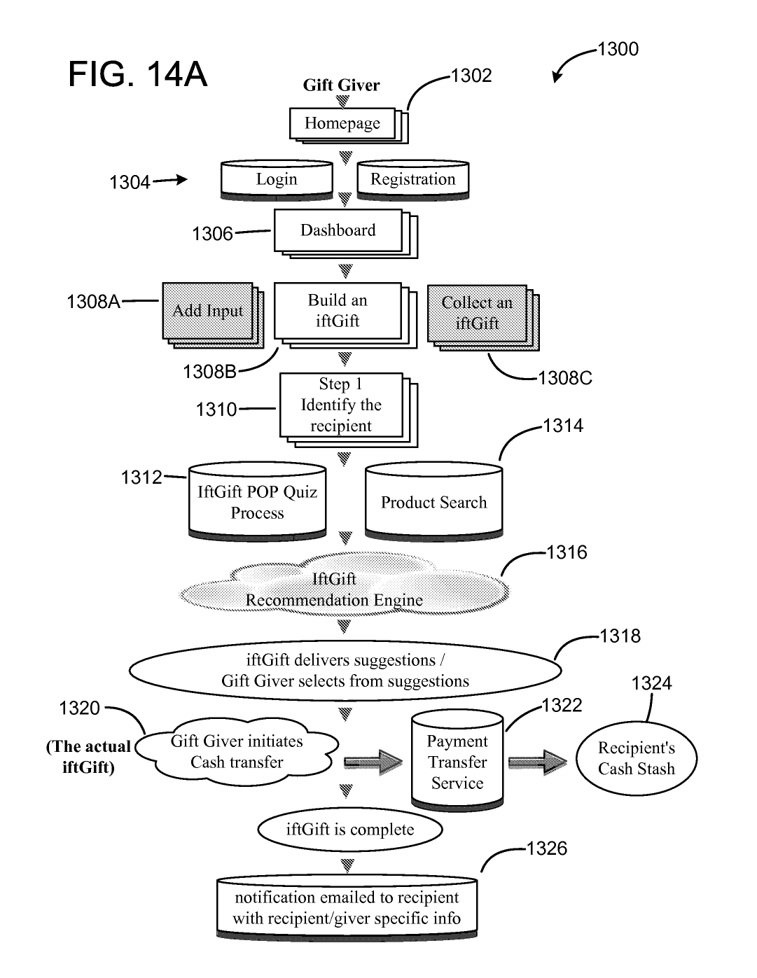

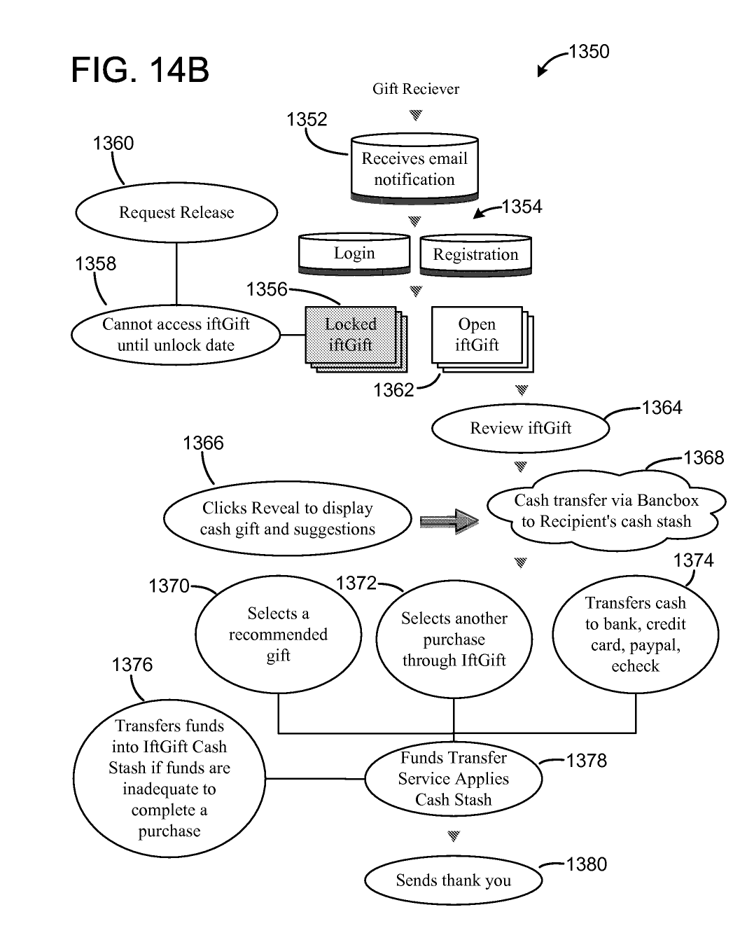

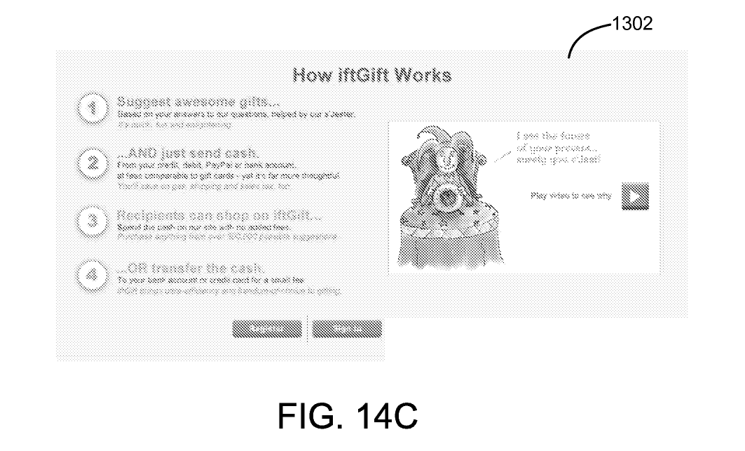

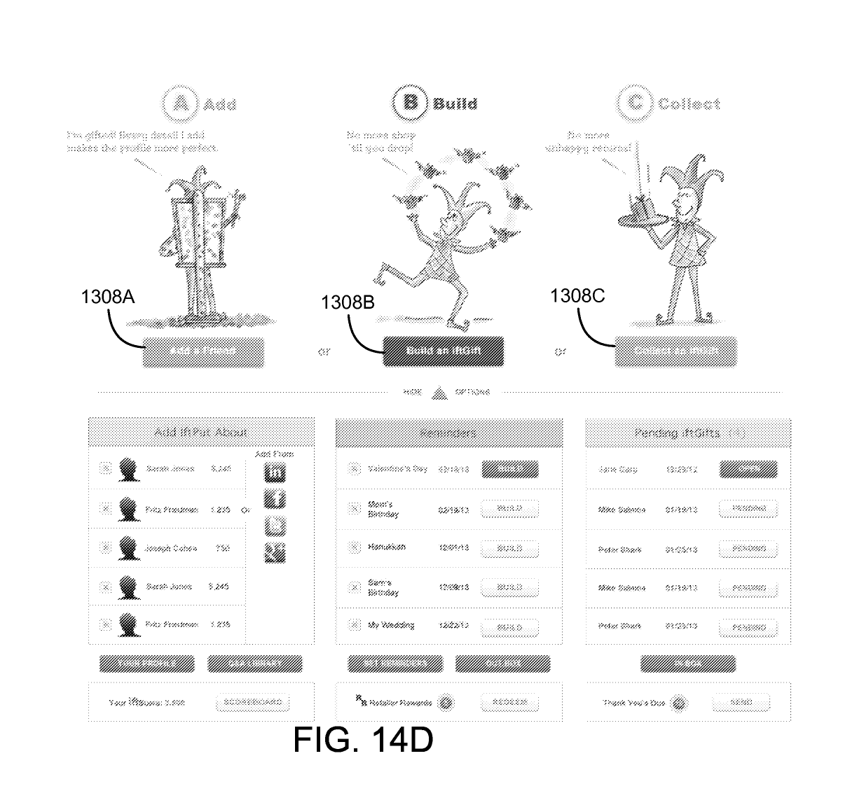

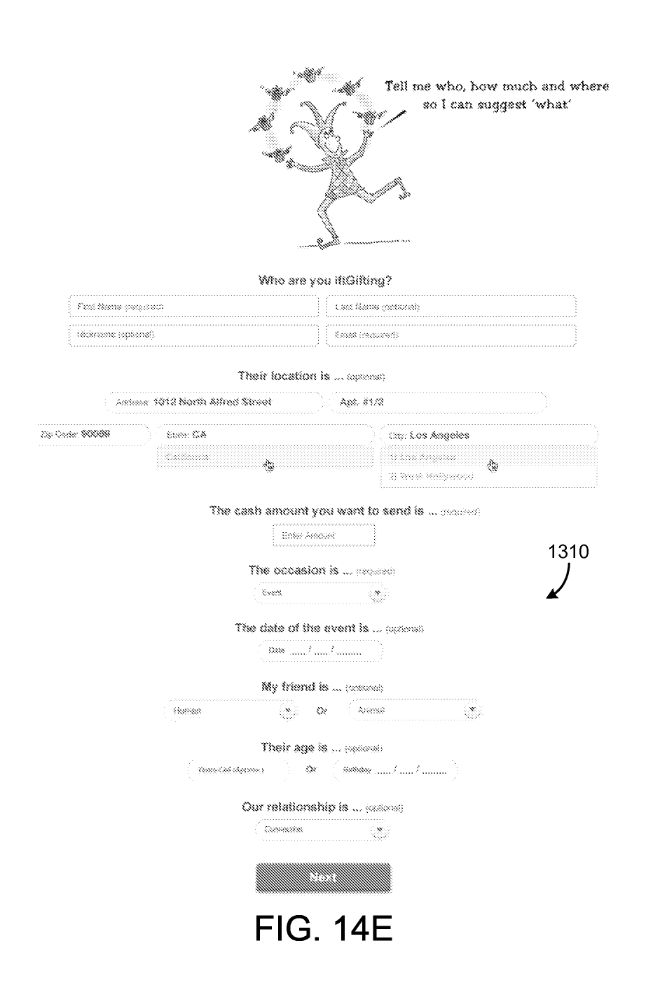

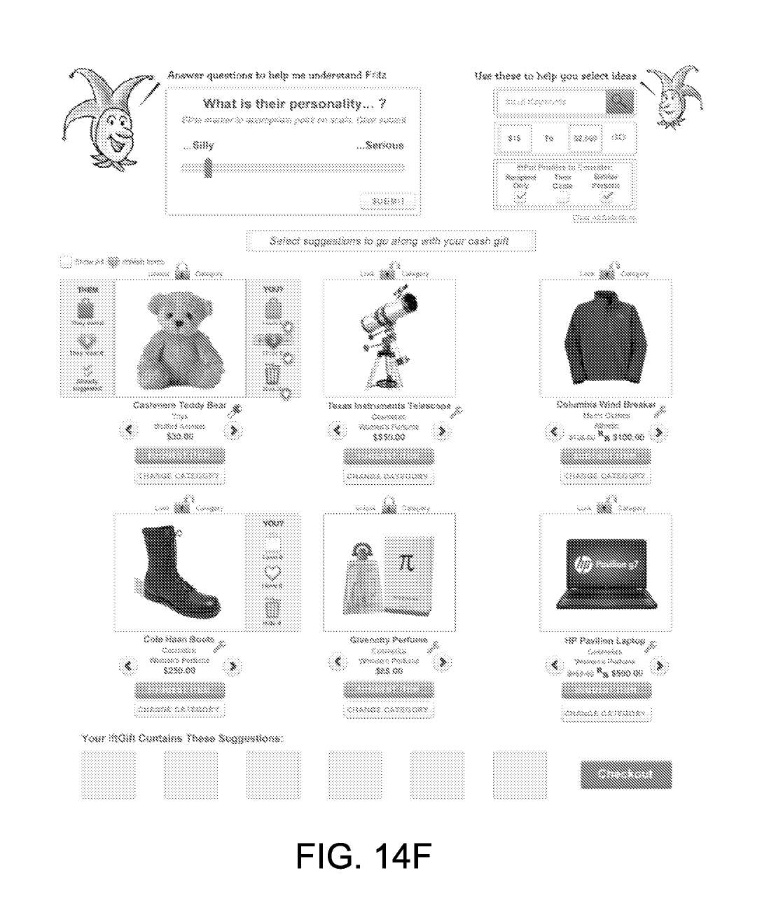

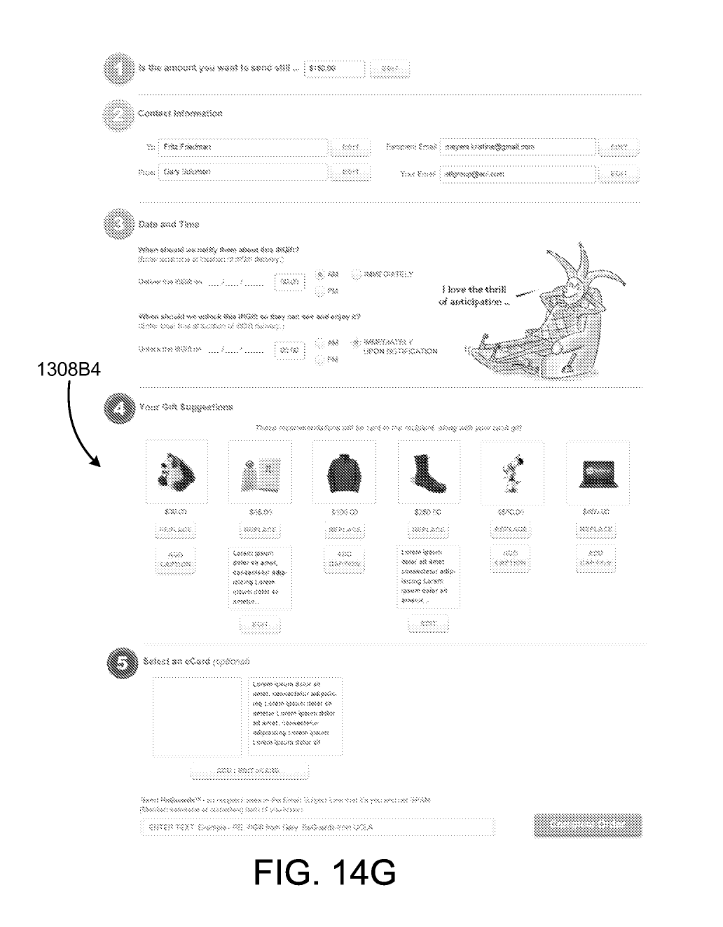

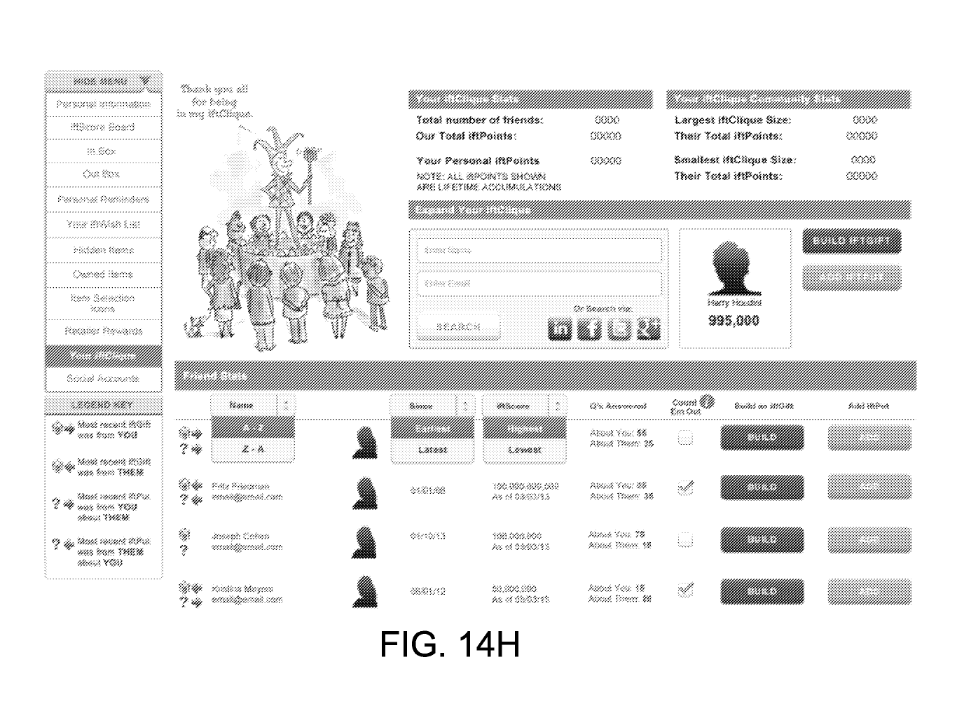

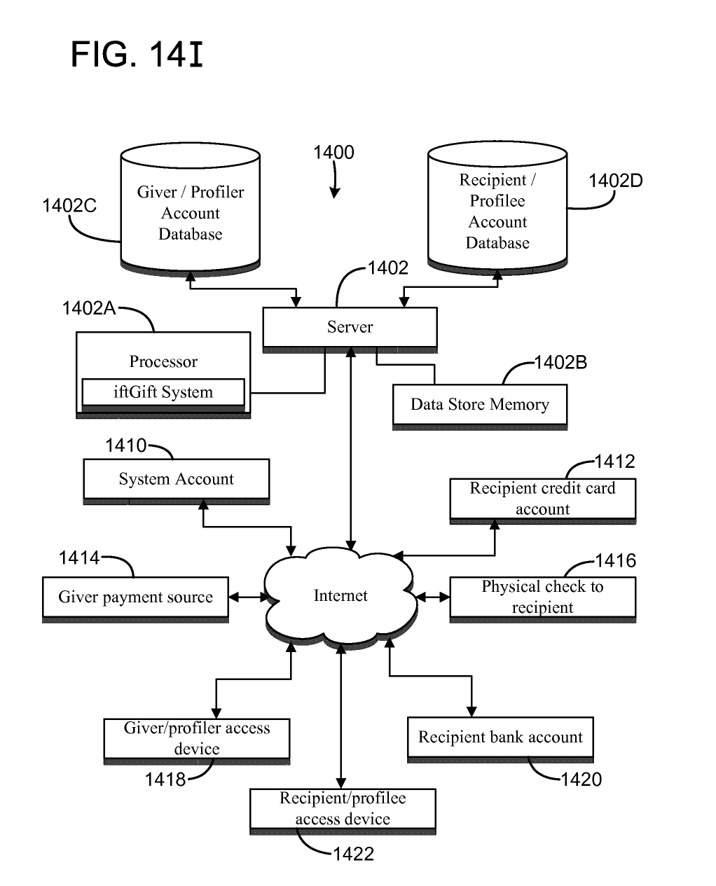

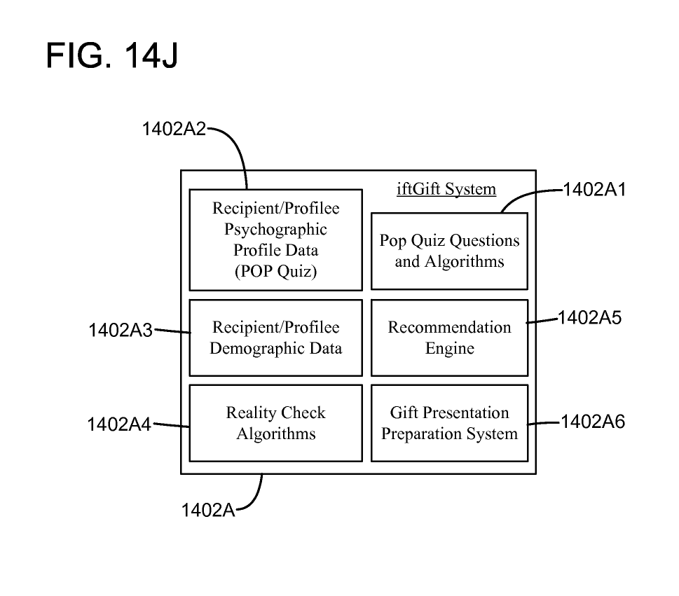

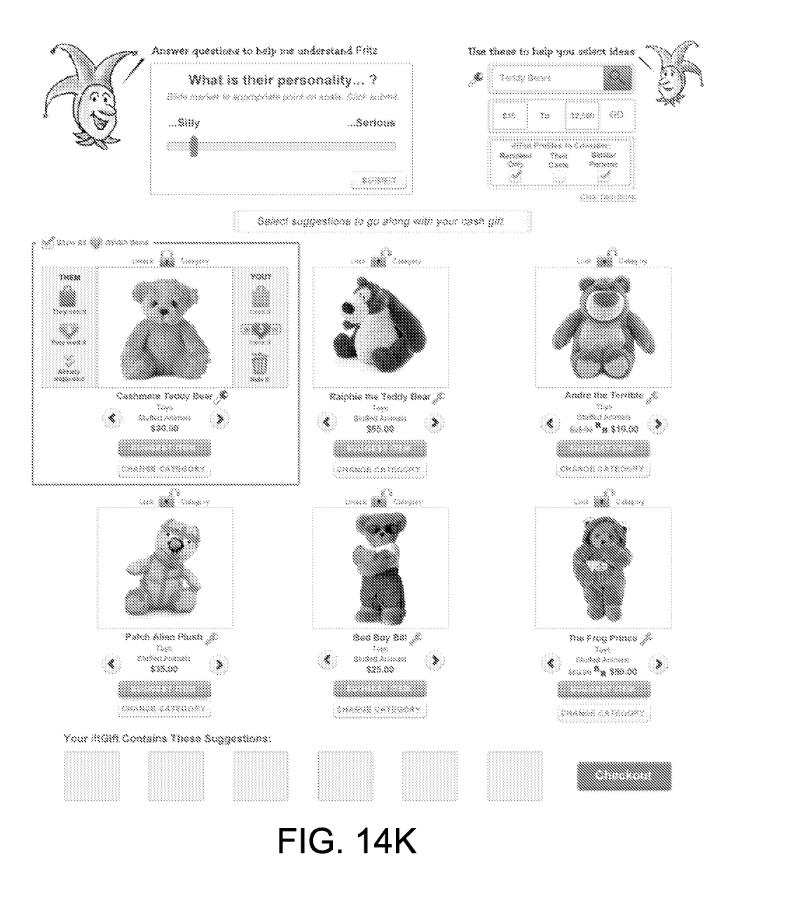

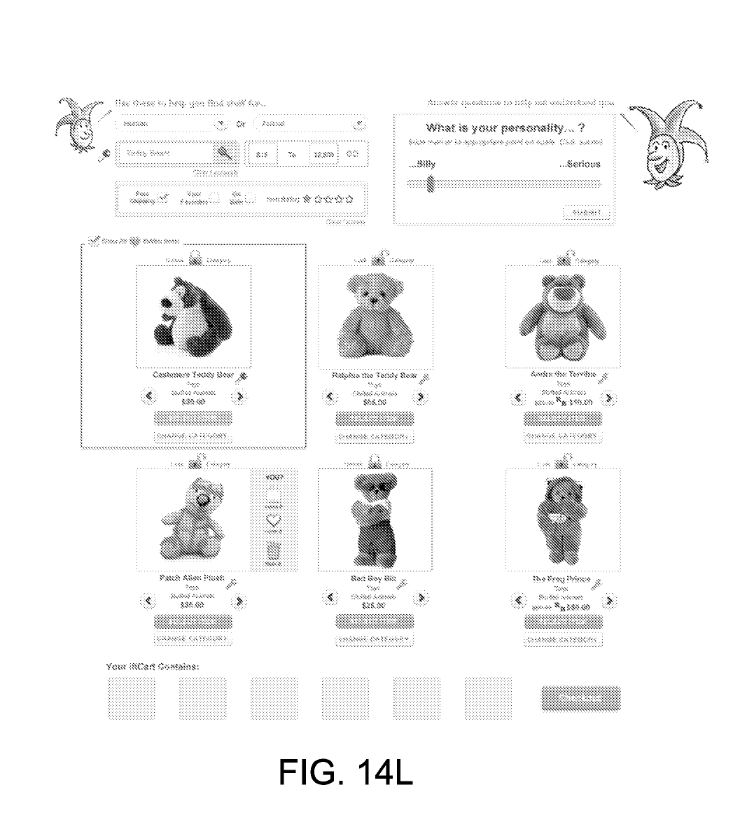

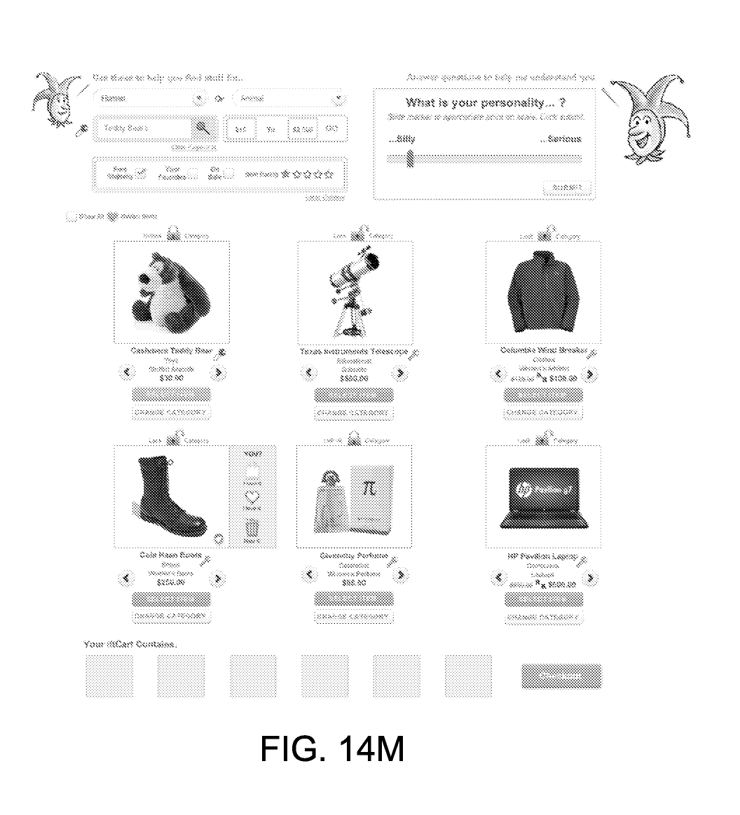

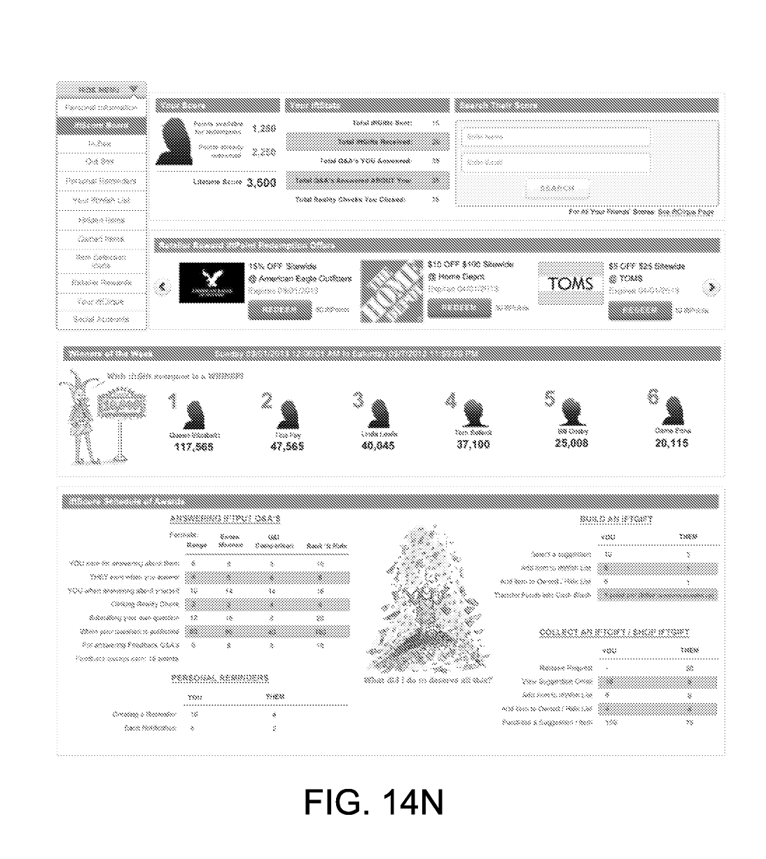

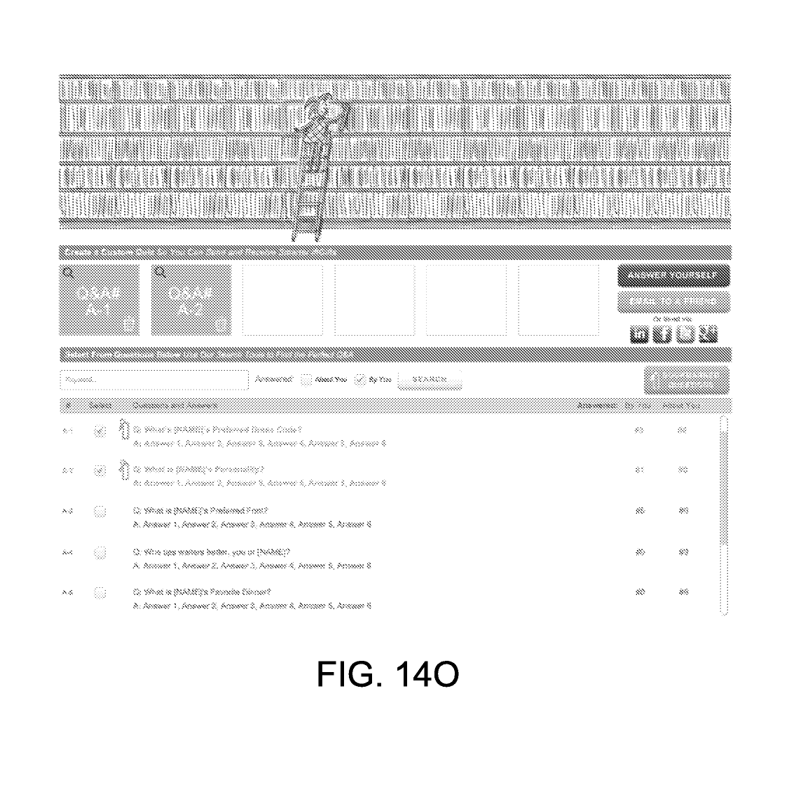

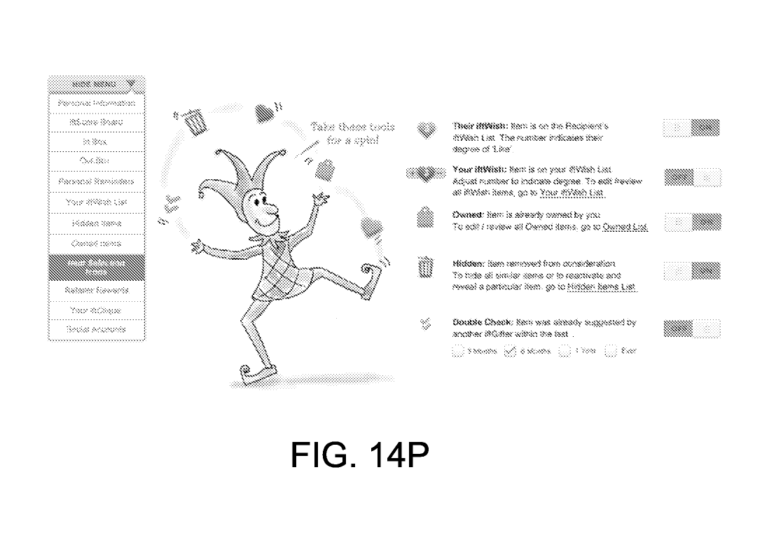

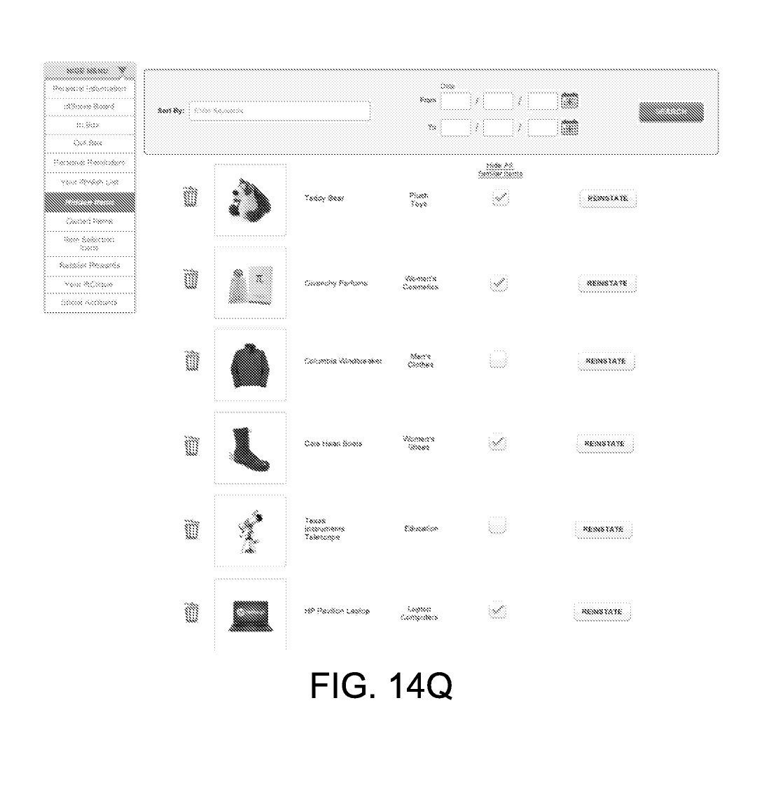

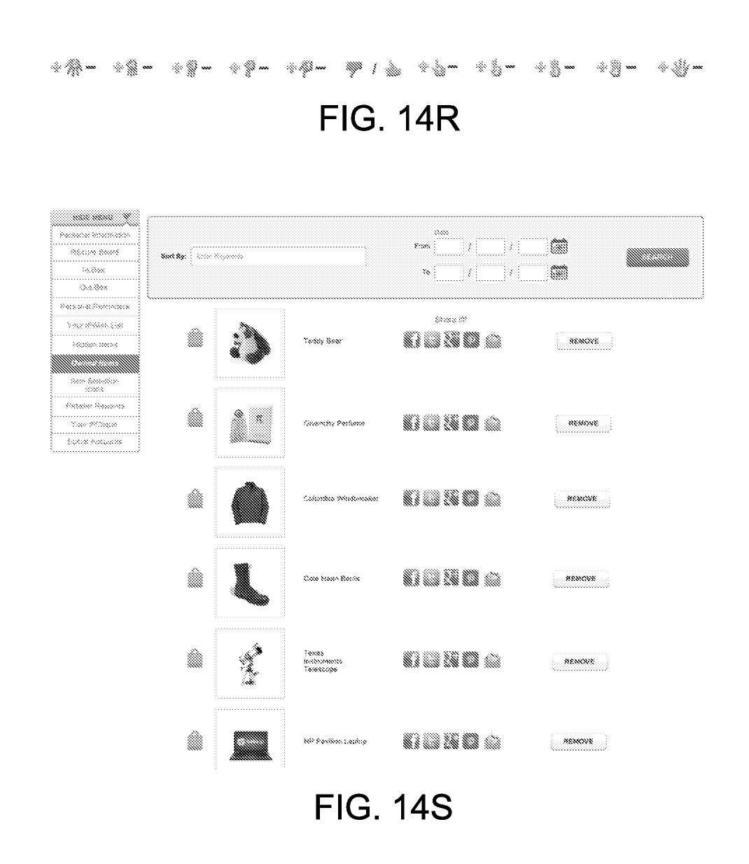

FIGS. 14A-14K further illustrate features of an exemplary system and method for electronic gifting. FIG. 14A illustrates a diagrammatic flow diagram of some features of an exemplary method 1300 for a gift giver to make a financial gift and gift suggestion(s). The gift giver uses a web browser running on an Internet-connected device to navigate to a homepage of a website 1302 running the method program, e.g. on a server connected to the Internet. FIG. 14C depicts an exemplary home page of such a website, the “iftGift” site. At 1304, the gift giver registers as a new user, or logs in as a registered user of the website. This login process can be performed by using email, existing social network registrations such as Facebook, Google or Linkedin, or other credentials such as user name and password. After the login process is completed successfully, the gift giver proceeds to a “dashboard” web page at 1306. FIG. 14D illustrates an exemplary form of the dashboard page, which presents the gift giver/user with several options, including the options to add input data at 1308A, build a gift at 1308B, and collect an iftGft at 1308C; other functions including those shown in FIG. 13A are not illustrated in FIG. 14A for simplicity. For the option to build a gift, at 1310, the program prompts the gift giver to identify the recipient. FIG. 14E illustrates an exemplary web page 1310 configured to prompt the gift giver to identify the recipient, enter some demographic information, and the cash amount of the gift.

At 1312, the user may choose to participate in a POP or iftPut quiz feature to establish or update a profile for the gift recipient, as summarized above, and explained in further detail below. Alternatively, or additionally, the user may choose to perform a product search at 1314. The results of the product search and the gift recipient profile may be used and/or driven by the gift recommendation engine at 1316. Other manual search tool aids such as keyword input, price range filters, filters to reflect the input of various groups, and wish lists may be provided to allow users to search for products to augment or bypass the recommendation engine. In an exemplary embodiment, the recommendation engine may drive the product search, which may in turn be enhanced or overridden by input and determinations by the user. The product search may also be implemented or enhanced by the use of third party search engines and/or data mining tools as described above regarding the embodiment of FIG. 12 The recommendation engine 1314 creates a selection of possible gifts (or transfers if, for example, the suggestion is a charity) for the gift giver to choose from. For example, the engine may determine a list of possible recommendations based at least partially on the iftPut quiz process data for the gift receiver, as well as the price range selected for the gift, and the possible recommendations displayed on a website page to the gift giver. At step 1316, the gift giver may select from the displayed recommendations one or more of the gifts to suggest to the gift receiver.

FIG. 14F illustrates one exemplary web page showing a gift building process, in which the iftPut Quiz feature is utilized along with keywords and price range to suggest possible gifts. The gift suggestions in this example are informed by the selected filter on the input profile to be considered, i.e. the recipient only, the recipient's circle or network of friends, and persons having a similar profile, even if unknown to the recipient. The recommendation engine 1316 selects and displays the gift suggestions according to the selected profile, gift monetary range and/or keywords. The gift giver may then select one or more of the suggested gifts to populate the iftGift for the recipient. In an exemplary embodiment, and as illustrated in FIG. 14F, during the gift selection and shopping processes, six different category viewing windows are provided, each displaying an individual item available within that category. By utilizing the left and right navigation arrows provided at each window, users may scroll through and review and select from all the various items available within that category. Changing the categories can be accomplished by either clicking the Change Category button below each window or by entering alternative search criteria within the various criteria selection tools provided in the upper right quadrant of the screen. While selecting and sorting through items and categories within the category viewing windows, the user is afforded the option to lock-in any particular category window so that the individual items within will remain available for review despite changes being made to the criteria selection tools. This is accomplished by clicking on the Lock icon above each category window. Though locked, scrolling through the items within the category can be performed though use of the left and right navigation arrows. When the user has completed review of the category, a click on the lock icon releases the category window to allow display of other categories.

In another iteration of the suggestion selection page illustrated in FIG. 14K, the functionality described above would be augmented with an additional feature. Over one of the six selection windows, (the top left selection window is used in the example displayed in FIG. 14K) a check button offers users the option to view all of the Recipient's iftWish items in one convenient place. Once the button is checked, the first iftWish item is shown and the window is locked and highlighted. Using the left/right navigation buttons the user can peruse all the Recipient-indicated iftWish items, regardless of category, and select a gift suggestion. When each new iftWish item comes on, the other five selection windows display directly competitive/alternative items, potentially ranked by price, customer rating or any other metric. While the iftWish item is being displayed, its iftWish numeric ranking is shown within the adjacent heart icon. Should the item be already owned or recently suggested, those appropriate icons will be displayed as well.

An alternate “Shop iftGift” page embodiment of the gift suggestion selection web page is depicted in FIG. 14L. This page may be viewed by a recipient when seeking items as alternatives to gift suggestions and also when simply seeking to make a purchase through the iftGift site in order to expend funds from their cash stash holdings. When viewed by the user, the functionality described in the suggestion selection page above may be augmented with an additional feature. Over or below each of the six selection windows a check button offers users the option to lock in the item of interest on view and to fill the other five boxes with directly competitive items. The competitive differences considered might be price, vendor, consumer rating, or other metrics. This will allow for immediate side by side comparisons of the nearly identical items and for rapid purchase selection and decision. Should more than five alternative items be available, certain of the left/right navigation buttons might flash to indicate that there is more content available to be reviewed. An alternative method, depicted in FIG. 14L, would be to have a key icon appear beside the item name. When the icon is clicked, the keyword portion of the item name appears in the keyword entry window, and all the items appearing in all of the selection windows are directly competitive items. Once an item has been selected for the shopping cart, or the initially utilized Comparative Shopping button or key icon, is un-checked, all the selection windows could return to displaying the content they contained prior to the engagement of the Comparative Shopping button (FIG. 14M).

FIG. 14G illustrates an exemplary web page for choosing and implementing the gift delivery details (1308B4, FIG. 13A). This will confirm the gift amount, recipient details, the gift suggestions, and allow the gift giver to select an ecard if desired.

At 1320 (FIG. 14A), the gift giver uses a funds transfer or payment service 1322 such as a credit or debit card, bank account, “Bancbox”, PayPal™ or the like to set up a cash transfer to an iftGift cash stash 1324 for the benefit of a specific gift recipient. This establishes a specific amount of the value of the gift in US dollars or other currency.

At step 1320, the system provides a notification of the gift, sent by an electronic message, such as email or phone text message, to the gift recipient. As a means of enhancing the comfort level of recipients receiving an unexpected email message, increasing the likelihood of the email being opened and diminishing the possibility that the email is part of a spoof email scam, the system allows the user the opportunity to insert into the subject line on the initial gift notification email or other electronic message a short message that would contain information known only to the gift giver and the recipient, i.e. recipient/giver specific information. An example of this might be: An iftGift from Sam Pike, how's your dog Spot? Or An iftGift from Sam Spike, dinner last Tuesday was great. This feature might be called Re:Guards, a coined term. FIG. 14G shows an example of an implantation on the delivery details page, in which the gift giver can enter text to be visible in the email subject line, of shared personal information knowable only by the gift giver and the recipient.

FIG. 14B illustrates a diagrammatic flow diagram of an exemplary embodiment of a method 1350 for a gift receiver to receive a financial gift or suggestion sent by a gift giver according to the embodiment of FIG. 14A. At 1352, the gift recipient receives the electronic message notification of the gift from the gift giver through the website, and logs into his/her account at the website, or registers as a new user, at 1354. Here again, the login can be performed through social media sites such as Facebook, Google or LinkedIn, or by login credentials.

When seeking to view the gift on the website, there may be an indication at 1356 that the gift is locked, and may not be unlocked until a specified unlock date (1358). As described in the above referenced U.S. Pat. No. 8,280,825, the gift may be subject to a lockbox hold, wherein the gift is not accessible to the recipient until a predetermined date. The receiver may request release of the gift earlier than the lockbox date, at 1360.

Once the gift recipient has logged into the account, and the gift is unlocked (1362) if it was subject to a lockbox hold as described above, the gift recipient reviews the gift at 1364, and e.g. by clicking a “Reveal” or “open” button at 1366 to display the cash gift amount and suggestions, the funds are transferred from iftGift's escrow to the recipient's “cash stash” account at 1368. The recipient may choose then to select a recommended gift (1370), to select another gift purchase through the “iftGift” website (1372), or to transfer the cash value from the recipient's cash stash to another of the recipient's account of choice, e.g. a bank account, a credit card, a “PayPal™” account, or to an echeck at 1374. Alternatively, the recipient may chose to leave the cash gift in the cash stash account until some future date. At step 1376, the system will transfer from the recipient's linked account, e.g. a bank account, credit card, or PayPal account, any additional funds needed to purchase the selected gift if the cash stash balance is insufficient to complete the purchase. Alternatively, at the point of purchase of a gift, other sources of payment could be used, to eliminate the need for an intermediary transfer into iftGift in cases where additional funds are needed to complete a purchase. At 1378, the funds transfer service applies the cash amount to purchase the gift, and the recipient, through the system, may send a thank you email to the gift giver (1380).

FIGS. 14I and 14J further illustrate features of an exemplary embodiment of a system 1400 for implementing the method of FIGS. 13 and 14. The system may include a giver/profiler access device 1418 (such as a pc, smartphone, tablet or other device connected to the Internet) that allows a giver/profiler to connect through the Internet to a server 1402 configured to run the iftGift software program 1402A and implement the methods illustrated in FIGS. 14A-H and 15-27. The server 1402 is linked to a data store memory 1402B for storing data accumulated during the iftGift processes, including the iftPut quiz process and the “reality check” process, explained more fully below. The server 1402 may also be linked to a giver/profiler account database 1402C and a recipient account database 1402D. The server includes a processor.

In some embodiments, the giver/profiler may enter a monetary value of a gift and billing information through the giver access device 1418 connected to the Internet, which is stored in a giver/profiler record in the giver account database 1402C. Once the transaction is completed, the monetary value of the gift, provided it is unlocked, may be transferred from the giver payment source 1414 to a system account 1410 through the Internet, and the value is recorded in a recipient record in the recipient account database 1402D. A recipient may access a recipient account associated with the website and the recipient record in the recipient account database 1406 through a recipient access device 1422 linked to the Internet to view the monetary value of the gift. The recipient may request a monetary transfer from the system account 1410 to either a recipient bank account 1420, a physical check 1416 to the recipient, or a recipient transaction card account 1412, by way of example only.

FIG. 14J illustrates an exemplary embodiment of the iftGift system 1402A, running on server 1402 (FIG. 14I). The system includes the iftPut quiz question database and algorithm (1402A1), the recipient/profile psychographic profile data (1402A2) and demographic data (1402A3). The Reality Check algorithms (1402A4) process the recipient/profilee data, as described more fully below. A recommendation engine 1402A5 generates gift suggestions based on the recipient/profilee data, and a presentation preparation system 1402A6 prepares the gift suggestions for presentation to the recipient/profilee.

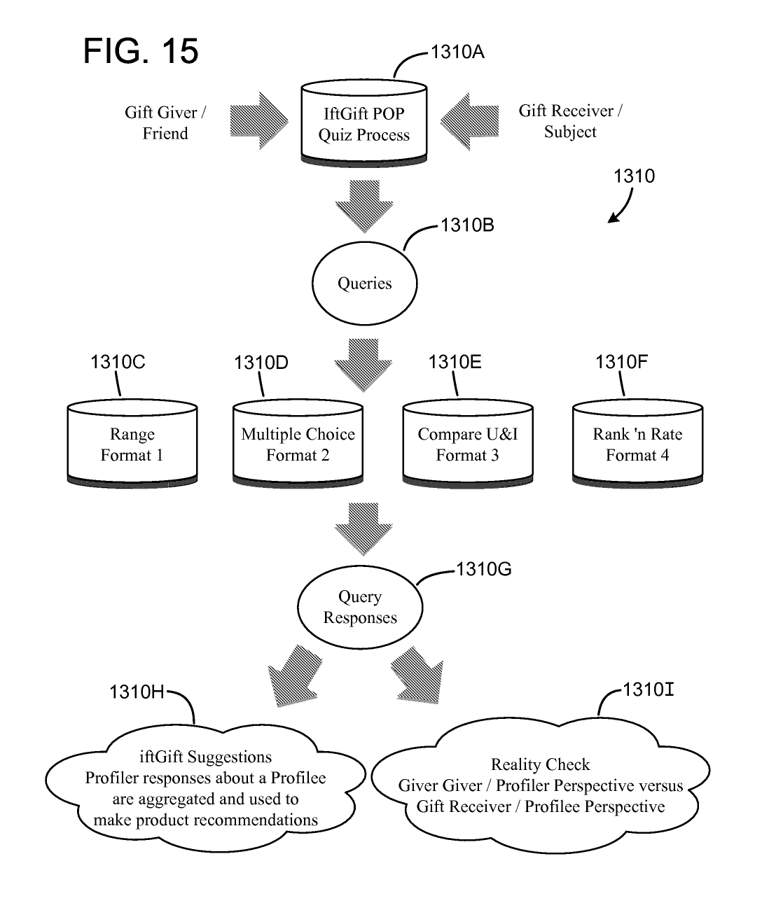

A process flow diagram of an exemplary embodiment of the iftPut quiz process 1310 is shown in FIG. 15. The process can be entered at 1310A, either through the gift giver process 1300 as shown in FIG. 14A, or by anyone logging into the iftGift website, and, using the input function 1308A (FIG. 13A), taking the iftPut quiz to provide a data profile for any individual that can be located through an email address or social networking account, for example, or to update an existing data profile for an individual. In another embodiment, a separate application can be implemented with the iftPut quiz process, for psychographic profiling of an individual. At 1310B, the web application running on the computer system (server) presents the questions to the user. The queries or questions may take any of a number of different formats, such as, for example, questions in which the answer is in a range (1310C), multiple choice (1310D), a comparison between the gift giver and recipient responses (U&I) (1310E), and a “rank and rate” format (1310F). The user provides the answers to the questions at 1310G, and the answers are processed at 1310H to contribute to a data profile for the profilee (subject individual). The recommendation engine processes the responses from profilers regarding the profile to make product or service gift suggestions. A Reality Check process at 1310I may provide a data profile from the perspective of an individual, or from the perspective of a gift giver, or from the comparison to various demographic segments and/or the total universe of responses to the question. Several examples are now described.

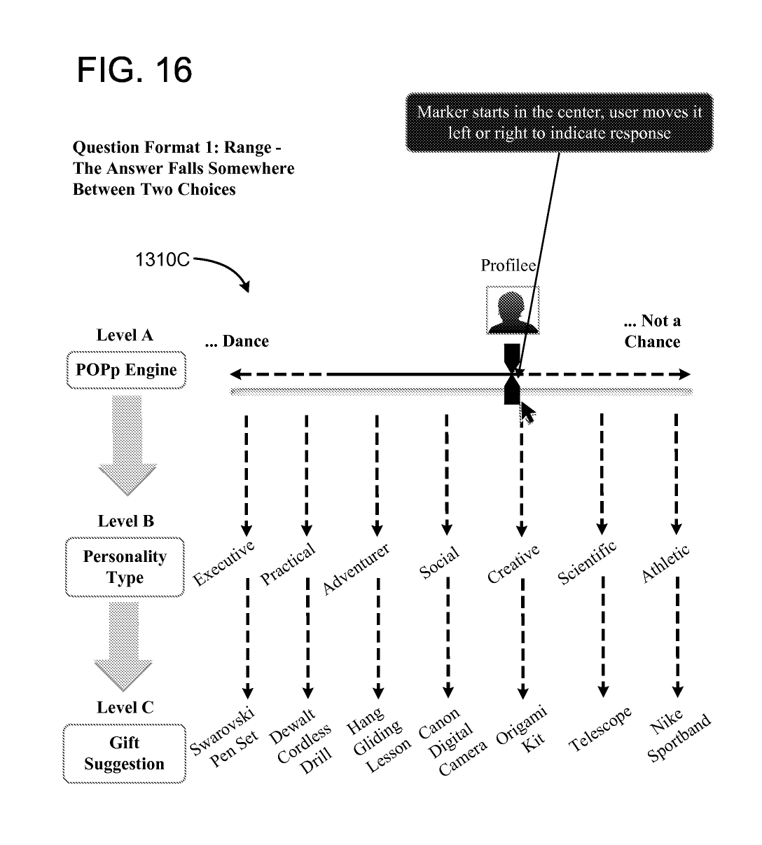

FIG. 16 illustrates an iftPut quiz question format for which the quiz taker provides a response in the form of a selection within a range. In the range format, at a process level A, a respondent profiler places the marker somewhere along a horizontal scale, with two extremely varied choices on either end of the scale. The selected answer would be associated, within the system but hidden from the user, with a particular personality type (process Level B). This in turn would be linked by the recommendation engine to a grouping of appropriate gift suggestions (process Level C). Thus, for the example shown in FIG. 16, the question involves whether the person being profiled would be likely to dance at a party. The range is from dance to “not a chance.” The recommendation engine at level A converts the selection to a personality type at level B, ranging from “executive” corresponding to “dance,” and athletic corresponding to “not a chance.” Each of the various personality types has associated with it a particular gift suggestion, at level C of the recommendation engine. Over time and with additional iftPut quiz results for the recipient, and optionally his friend circle and/or others like him, actual gift recommendations and purchases selected by users will inform and expand the gift suggestion pool. By aggregating intersecting and overlapping personality types derived from the answers provided by the entire universe of profilers for a given person, and the actions taken thereupon, a pool of potential gift suggestions can be identified.

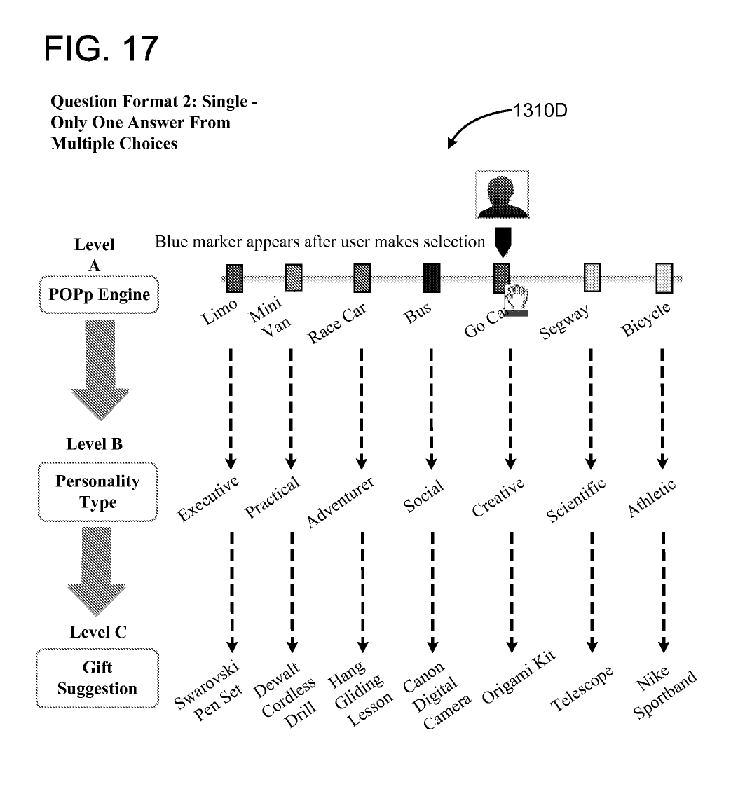

FIG. 17 illustrates an example of a multiple choice, single answer iftPut quiz question. In this example, multiple choices are presented as a response to a given question, and the selected answer at level A of the recommendation engine is translated into a personality type at level B, with a corresponding gift suggestion at level C. In this example, the question is to choose the profilee's preferred vehicle (or “ride”), and the answers range from a limo to a bicycle, with corresponding personality types and gift suggestions. As above, over time and with additional iftPut quiz results for the recipient, actual gift recommendations and purchases selected by users will inform and expand the gift suggestion pool. By aggregating intersecting and overlapping personality types derived from the answers provided by the entire universe of profilers for a given person, a pool of potential gift suggestions can be identified.

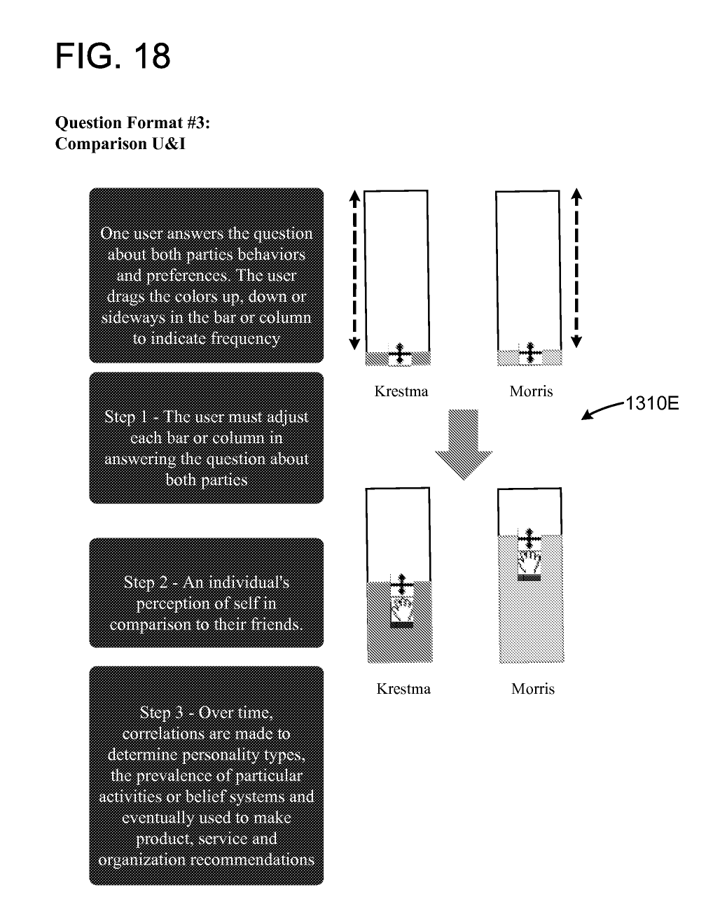

FIG. 18 illustrates an example of the comparison (you and I or “U&I”) question/response format 1310E. Within this format, questions are posed so that respondents are called upon to draw comparisons between a subject individual and another individual, perhaps the respondent him/herself. For example, “Who eats out more often, Morris or Kristina?” The respondent is presented with two columns or bars, one marked with the gift recipient's name (Morris in this example), the other column or bar represents the respondent user (gift giver). When U&I questions are initiated by an individual in, for example, a custom quiz, the answers for comparison could be requested about any two known individuals, not just respondents. The columns may be colored and marked at the end of the column or bar. An up/down or more/less arrow slide indicator allows for raising or reducing the color gradient within the columns or bars, which allows the respondent to adjust the two columns relative to each other. The single user answers the question with their perception about both parties' behaviors and preferences. This format is intended to inform the system of the prevalence of one particular personality type, behavior and/or preferences so as to enable product or category recommendations.

There is not necessarily a clear link between the answer to any question in any format and an actual gift suggestion. If for example, a majority of males who eat out frequently purchase or have a restaurant voucher suggested as a gift, then a restaurant voucher may appear higher up in a list of potential gift suggestions. However, unrelated items, e.g. a majority of males who eat out frequently show a propensity for sneakers, might also make sneakers appear high up in the recommendation hierarchy and would therefore be suggested.

As with all the question formats, over time other of the user's friends visiting the site might also confront and answer this same question. Over time, the comparison U&I format 1310E develops indirect correlations to determine personality types, the prevalence of particular activities or belief systems and can eventually be used to help make recommendations.

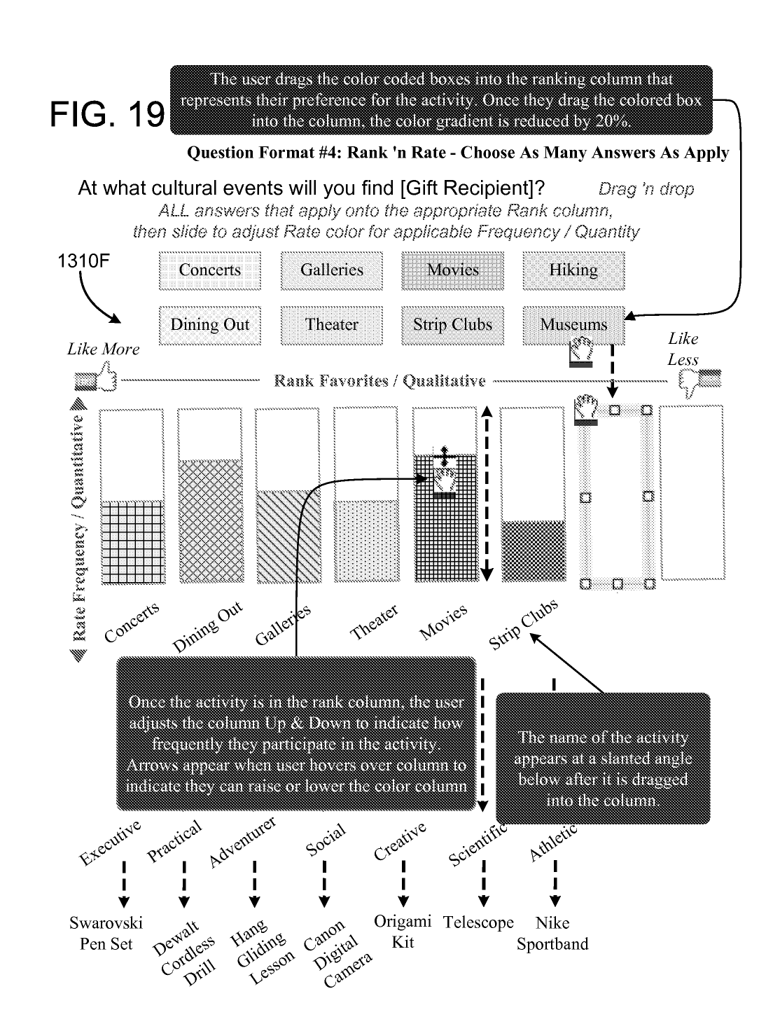

Certain of the questions could be posed and answered utilizing a rank and rate format 1310F, a multi-measure, bi-axial methodology and graphical interface. An example of this format is shown in FIG. 19. A question is presented, with a number of potential answers relative to the subject profilee presented as a title, an icon, a photo and/or contained as a written word in separate colored boxes. In this case, the question is “Which cultural events does [gift recipient] attend?” Any or all of the answer elements could be dragged and dropped onto a series of columns or bars, which are organized along an axis. After a user profiler drags an answer into a column or bar, a shadow representation of the answer could remain in their original positions for reference. In the exemplary graphical treatment depicted in FIG. 19, the answer choices that apply may be dropped onto the bars in preferred order for the subject item/activity or any other metric, with bars ranked from 1 to 8 provided. The other axis could measure “<Quantity/Frequency>” or any other applicable metric, and it may be adjusted by using the arrows for increasing or reducing the color gradient within the column or bar. In the example shown, this indicates how much time the profile subject spends involved with the particular subject item/activity. In another embodiment, this rating could be accomplished by allowing the user profiler to enter a number from a predetermined numerical scale, for example from 1 to 5, to indicate how much time the subject profilee gift recipient devotes to the specific ranked activity.

These adjustments in all question formats may also be accompanied by sound effects, with perhaps a different up/down sound effect for each column, thus providing the opportunity of creating a colorful cacophony. When the respondent profiler is satisfied with the adjustments, a button click locks-in the results.

In an exemplary embodiment, one purpose of the rank and rate methodology is to help establish identification metrics upon which the suitability of various gift suggestions may be ascertained. This format can also have the further advantage of being a ‘field level research tool’ with the ability to identify potential areas that may be adjusted to achieve, for example, increases in workplace productivity, operational efficiency and educational outcomes.

In an exemplary embodiment, the user/recipient/profilee does not have to give permission for the profiler to answer questions to update the profile. However in other embodiments, permission may be required.

For each answer provided in the iftPut quiz function, the system may ascribe a numerical point value for each answer provided. Points may be earned and accumulate on behalf of both the respondent profiler and the subject profilee. Points can also be earned for other actions undertaken on the site, such as selecting gift recommendations, contributing additional questions, making referrals to outside friends, purchasing an item or transferring funds, to name some examples. In an exemplary embodiment, almost every activity engaged in on the iftGift site may have an ascribed point value, with points being awarded to both the user taking the action and the person about whom the action was undertaken. These activities may provide input upon which the recommendation engine algorithm bases future gift suggestions. Thus, the collection of points may allow a user embarking on a gifting session about another individual to readily ascertain the caliber of input upon which the system is basing its recommendations; the higher the score, the more thorough the input, the more accurate the gift suggestions and vice versa. If the score is low and the user would like enhanced accuracy, he is provided the means to do so, by answering some iftPut questions.

Once established, the point system can, however, accomplish much more. For one, it encourages longer involvement with the site, particularly if the score is low at the start of a gifting session.

Since an individual can earn points even prior to actually signing up as a user, as an iftGift recipient for example, the point system serves as a “sampling” incentive.

While the iftGift website application may be centered on a social activity, the giving of a gift, the social networking aspect of the site need not stop there. As with all human endeavor for which points are awarded, frivolous or not, i.e. a sports team fan or a high earning employee, a point system imbues a sense of competitiveness that drives depth of involvement, further momentum and expansion through social outreach. An iftStat-filled iftScore Board page, e.g. as shown in FIG. 14N, may be provided as a web page, where users can compare and parse their point standing vis-a-vis others, as well as learn of ways to increase their own points. This competitiveness may be enhanced by establishing friend circle ‘teams’ or “iftCliques” (FIG. 14H), and their membership rolls and cumulative scores may be used to help drive both a sense of competitiveness and community.

The point system may also be evolved into a rewards program similar to airline miles, where points are redeemed for item discounts and other opportunities of value.

Point values could vary based on question format, type of action; who undertakes it; or even dates/times the actions are undertaken. The continually growing number of points earned by both the profiler and profilee could be displayed simultaneously on the user's page at the website, as illustrated in FIG. 14N. Respondents may see both his/her own and the subject's cumulative point score while logged in. If multiple respondents are answering questions about a subject, all the respondents can see the subject's points and see the scores accumulate dynamically. Alternatively, these cumulative scores could be displayed as discussed below.

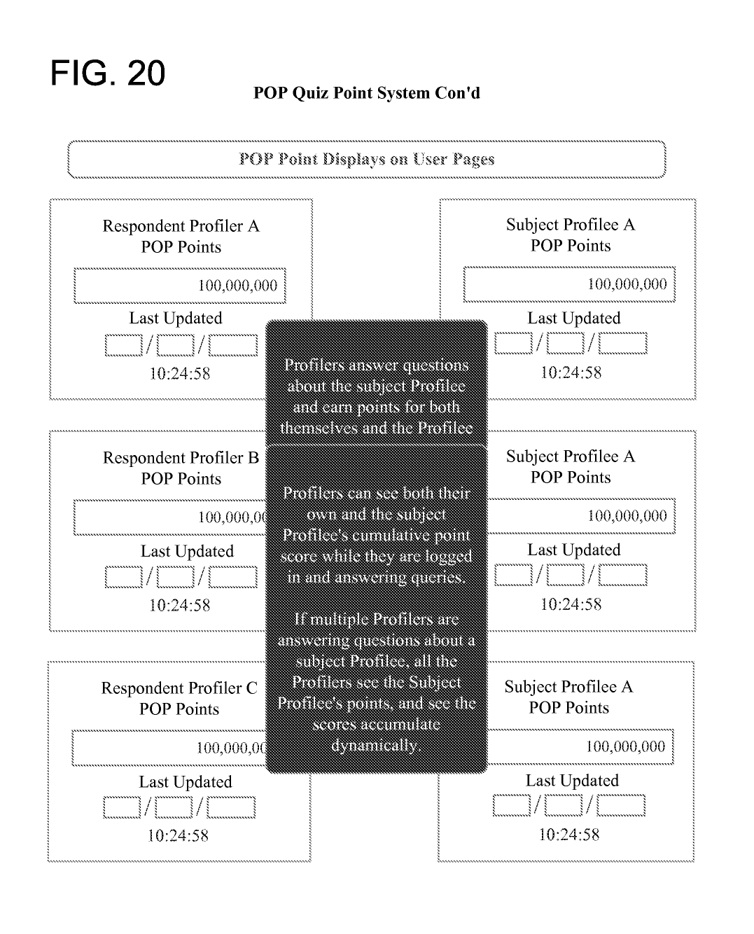

Preserving User Profiler Anonymity. While the identity of specific responders and their actual responses may not be explicitly revealed to other parties, a profilee determined to obtain such information might studiously probe his friends' evolving point scores, contrast them with changes in his own profile and/or tallies shown in Reality Checks and/or the Question Library and tacitly infer what his friend's answers to particular questions were. To forestall this activity, the posting of answers, points, etc, may be delayed until three separate responses from different profilers have been collected. Another method might be employed in the alternative. While the impact of all answers could be factored into the user profile immediately upon data entry by the system operating invisibly in the background, all such tallies displayed in the foreground, where they would be visible to users at various places within the website, would be batch posted at particular times. That is, display of the total numbers would be delayed until a fixed interval, for example each Tuesday at noon. At that time all points earned by that individual since noon the previous Tuesday, as well as the tally for how many times a question was answered would only then become visible. To make this information even more difficult to track, this ‘refresh time’ could be randomly generated by the system, with different, unpredictable time lags between each batch posting. To help users understand that a delay has been implemented, in places where scores or tallies are posted, the time they were updated can be displayed. For example: iftScore 235 as of Jan. 29, 2013—23:45. Or Question 45 Answered 8 times, as of Jan. 29, 2013—23:45. See FIG. 20.

Over time, both profilers and profilees would be able to repeat the exercise and may answer some of the same questions multiple times. Once a user answers a question, the system may not present the same question for a predetermined period of time. A profiler could elect to enter into a designated Question Library page, e.g. as illustrated in FIG. 14O, where all questions are available for display and possibly available to be answered. A method allowing users to select specific questions and to email them to anyone for answering may also be provided.

In addition to compiling and recording the answers to the questions about a subject profilee from any number of respondent profilers, the system may also be configured to identify, isolate and record the answers to those same questions as provided by the subject profilee about himself/herself as well as designated individuals. Upon entry of these answers the system may offer a methodology for comparing the current answers against those of various other groups of responders. This methodology is sometimes referred to herein as a “Reality Check.”

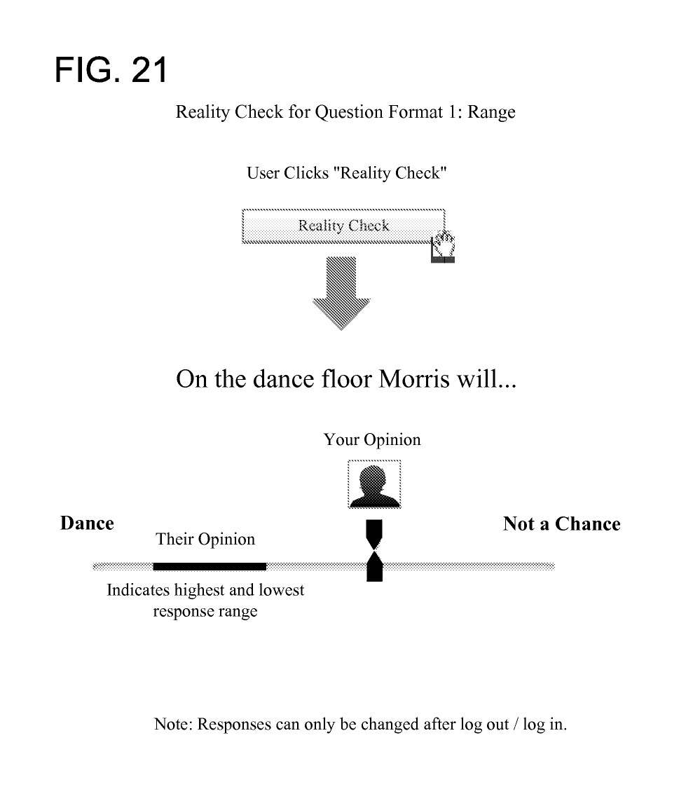

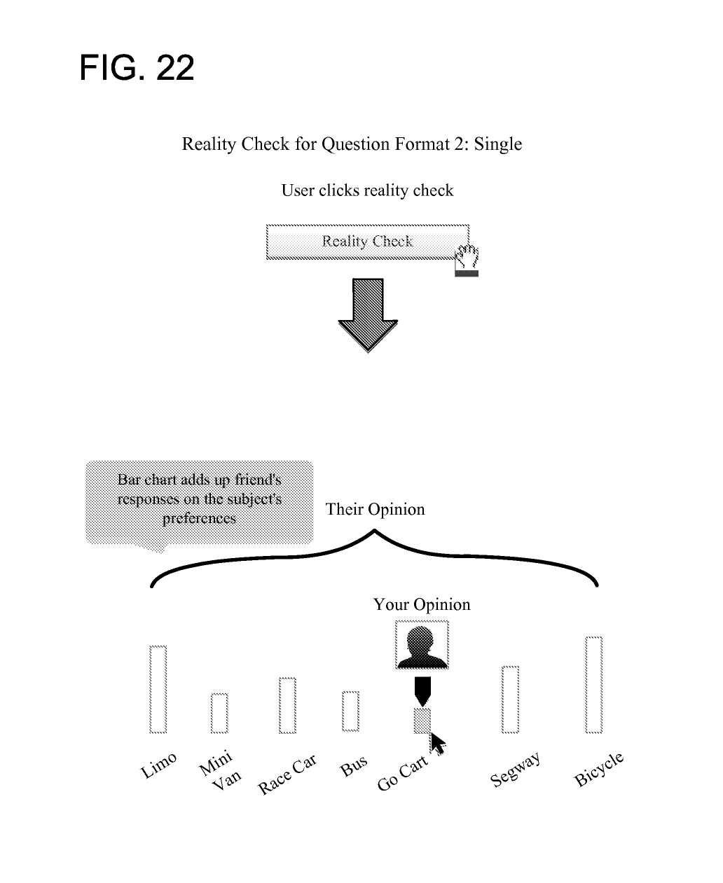

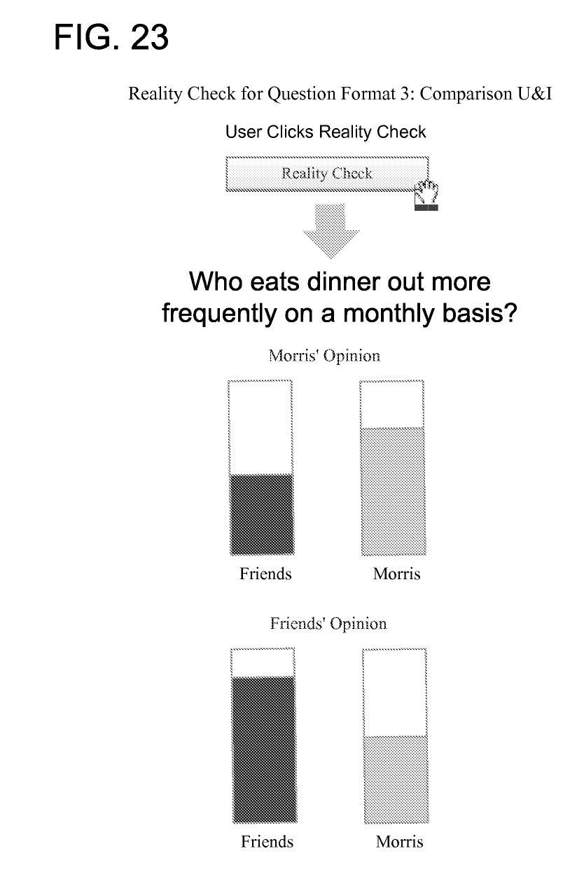

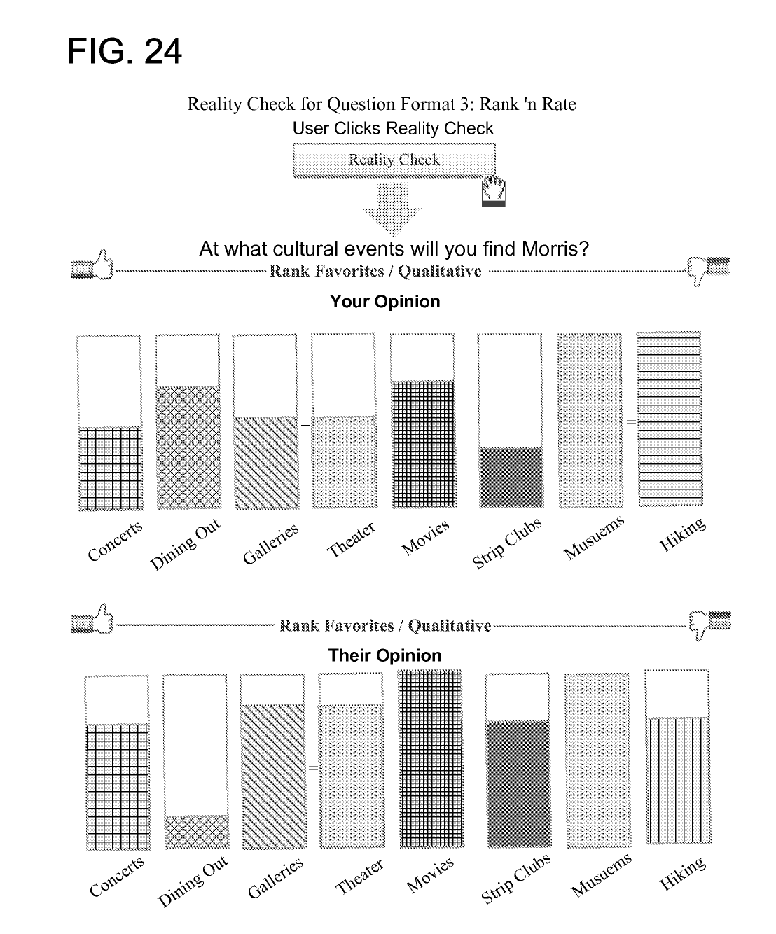

Upon request of a subject profilee, the system may be configured to generate data to display the aggregated/averaged answers of all respondent profilers, the subject individual's circle of friends (sometimes referred to herein by the coined term “iftClique”) and various other defined groups of responders, and compare them to the subject profilee's current responses, whether those current answers are about the profiler himself or another profilee. These would be displayed within graphical representations of the various question formats. In this way the profilee can compare his/her answer choices to those of other respondent profilers and/or other demographic groups. FIGS. 21-24 illustrate several examples of how the comparisons may be organized and displayed. FIG. 21 illustrates how a comparison can be displayed for a range type of question. FIG. 22 shows a bar chart comparison for a multiple-choice type of question. FIG. 23 shows a comparison for comparative answers between two different subjects (U & I format). FIG. 24 shows a graphical example of a comparison between the responses of profilers and the profilee for a rank and rate type of question.

These “Reality Check” displays provide the profiler individual with unique learning opportunities. If the profiler is answering about him- or herself, they can immediately see how accurately their self-image perceptions match or diverge from those of the general universe of respondents or more specifically defined groups such as friends, family, co-workers, acquaintances, or other defined demographic groups. In instances where the profiler is answering about a third party profilee, the profiler can immediately see how their perceptions of the subject profilee match or diverges from those of the various defined segments. The opportunity may be provided to the profiler to change or adjust their answers after the ‘Reality Check’ results are displayed. In another embodiment of the present invention, this specific activity of changing one's answers may be prohibited or restricted.

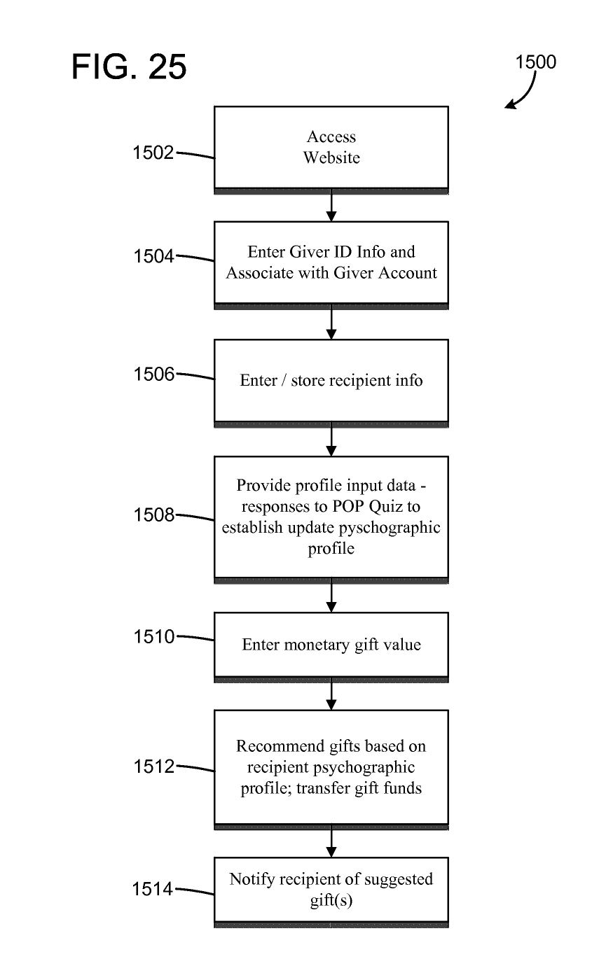

A computer-implemented method for electronic gift giving has been disclosed. In one embodiment, generally depicted in FIG. 25, the method 1500 includes:

(a) providing (1502) an internet site for access by a first giver via a first giver device;
(b) prompting (1504) the first giver to enter giver identification information and associating the giver information with a giver account;
(c) storing (1504) the first giver identification information in a data store;
(d) prompting (1506) the first giver to enter first recipient information defining a first recipient;
(e) prompting (1508) the first giver to provide profile input data in the form of a subjective assessment of what the appropriate answers are relative to the first recipient to a set of questions to provide profile input data to establish or update a first recipient psychographic profile of the first recipient, the set of questions including questions seeking physically descriptive and psychographic data about the first recipient, the first recipient profile stored in a recipient profile data store;
(f) prompting (1510) the first giver to enter a value of a monetary gift;
(g) using (1512) the first recipient profile to recommend at least one gift or transfer of funds that may be obtained using the monetary gift, wherein the recommended at least one gift or transfer of funds is based on the first recipient profile established or updated by the first giver. Alternatively, as indicated by the phantom line from 1506 to 1510, the gift giver can chose to bypass step 1508, and instead base the gift recommendation on the existing, pre-established recipient profile without providing profile input data and responses to iftPut quiz questions.

The platform may integrate with social networking sites, such as Google and Facebook, so that users automatically have the ability to invite their contacts to participate in iftPut Quizzes, thus expanding the “reality check” methodology network.

In an exemplary embodiment, after a time interval of having initially answered a question, for example three months, all respondent profilers, including the subject individual profilee, would be allowed to reenter their answers, which would accommodate changing behaviors, attitudes, circumstances and perceptions. A profiler could do so on a “Question Library Page”, which is discussed above. The latitude may be provided to either allow unrestricted answer modification in the Question Library or in the Reality Check mode, or to overlay various restrictions operating in the program's background

The “Reality Check” methodology may provide participants with an instant, insightful, easy and anonymous touchstone establishing how accurately their self-perceptions and cognition match social reality. In turn, knowledge of how one actually perceives or is perceived by others, as well as understanding social sphere expectations, could help motivate self-behavior modification to shape one's actions, reactions and interactions in real and/or hypothetical circumstances.

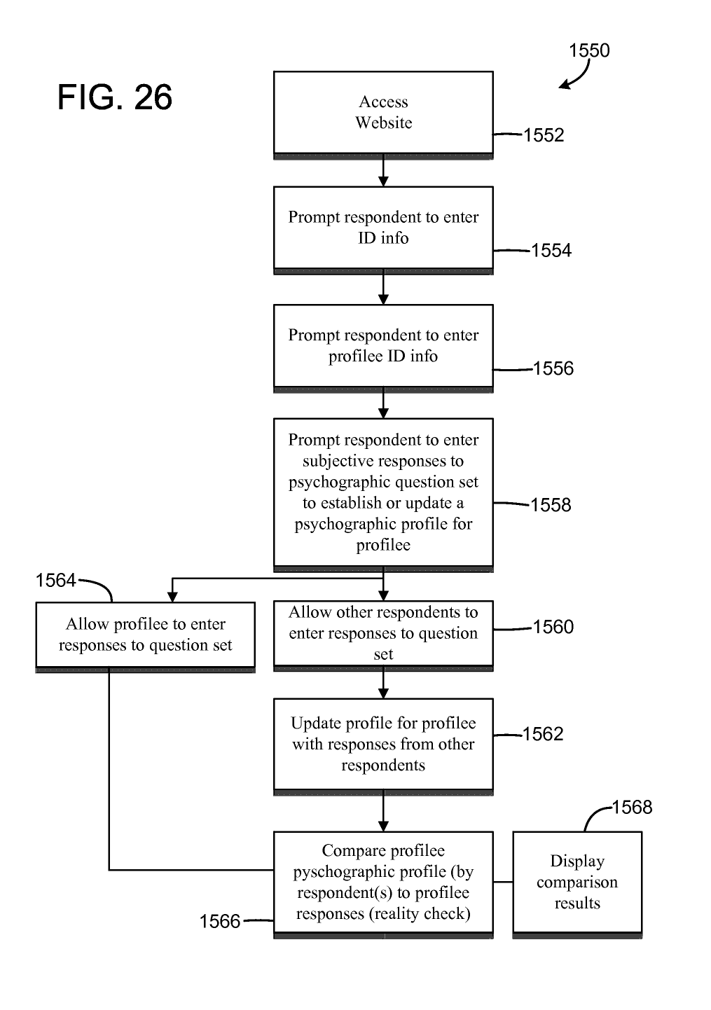

Additionally, this “Reality Check” methodology could be applied in myriad circumstances and applications, such as political polling and market research, as well as improving classroom conduct and educational outcomes, military morale and chain of command discipline, and general workplace team-building, by augmenting hierarchical performance evaluations with fair, anonymous and non-threatening peer group assessments. The methodology may provide the ability to perform self-directed and self-imposed psycho- and socio-therapeutic analysis with behavior modification potential. FIG. 26 illustrates an exemplary computer-implemented method for generating a psychographic profile of an individual person to-be-profiled, the method 1550 including a sequence of the following steps:

(a) providing (1552) an internet site for access by a first participant-profiler via a first device;
(b) prompting (1554) the first participant-profiler to enter participant identification information and associating the participant information with a first participant-profiler account;
(c) prompting (1556) the first participant-profiler to enter information defining an individual person to-be-profiled;
(e) prompting (1558) the first participant-profiler to provide profile input data in the form of a subjective assessment of appropriate answers relative to the person to-be-profiled to a set of questions to provide profile input data to establish or update a psychographic profile of the individual to-be-profiled, the set of questions including questions seeking physically descriptive and subjective psychographic data about the first recipient, the psychographic profile stored in a profile data store;
(f) repeating steps a)-e) for a second and subsequent participant-profilers to update the psychographic profile for the individual to-be-profiled.

The method may further provide for the profile to access the website and enter responses to the question set (1564), to compare the profile psychographic profile generated by third party respondents to the profile responses, to conduct the reality check (1566), and to display the comparison results on a user device (1568).

A comparison or scoring process may be implemented for the “reality check” methodology. Several exemplary comparison processes are described.

Range: In this mode, the comparison process shows the high and low range of respondent profiler answers about a subject profilee along a baseline scale, with the subject's specific choice indicated by a visual marker.

Multiple Choice: In this mode, the comparison process aggregates respondent answers about a subject profilee, and displays them in a bar chart, with the subject profilee's specific choice indicated by a visual marker.

Comparison U&I: In this mode, two columns of aggregated scores are displayed side by side, provided the same question has been previously answered by an adequate number of responders: Column 1) Profilee about him/herself; and Column 2) all others about Profilee

Rank and Rate: When viewed in this mode, the subject sees two groupings of color columns. The one marked ‘yours’ displays the subject profilee's ranking and rating of the answers. The one marked ‘theirs’ displays the statistical aggregate/average of the respondent rankings and ratings provided by their friends. Should that averaging process for rank and rate multiple choice questions ever result in a tied ranking of any of the horizontal measure elements (favorite/quality), an equal sign would appear between those columns garnering equal favoritism, indicating that they are of equal rank. Alternatively, they could be numbered sequentially, with the same number being used to identify statistically tied results (i.e. 1, 2, 2, 3, 4, 5, 5).

In an exemplary application, a purpose of the questions is to help establish identification metrics upon which the suitability of various gift suggestions would be ascertained. The system initially, subjectively and perhaps manually by a user, through search tools that may be provided, ascribes certain gift items as being appropriate for individuals who have particular answers in their profiles in common. Over time the commonalities of answers would provide profilee correlations even when no identifiable rationale exists; i.e. forty-eight year old males with red hair who live in upper income zip codes may demonstrate a propensity for baseball, romanticism, chocolate and riding on trains. The system's algorithms may be configured to aggregate these characteristics with specific gift ideas selected for actual recommendation to these individuals, as well as with items viewed and purchased by them. In addition, other actions undertaken on the site, as well as the answering tendencies of individual profilers, may all allow the system to impute a wider range of objective, measurable data, thus instilling more predictability and accuracy in the gift recommendation process.

Double Check Feature. In an exemplary embodiment, the IftGift system utilizes a “Double Check” feature which may prevent gift givers from sending duplicate suggestions. The feature shows gift givers if any of the currently displayed gifts were previously recommended to the recipient. It does not show who sent it. If desired, the giver could then change to another gift item. The time frame this feature considers may be selected and set by the user within the control preference files. This feature is illustrated in the exemplary web page of FIG. 14P

Enhanced Wishlist Feature. This feature expands on the basic functionality of the familiar website feature typically known as a Wishlist. A Wishlist allows a user to indicate a positive disposition toward certain site content, such as a purchasable item, which is linked with the Wishlist icon. The user does this by ‘activating’ or ‘highlighting’ the icon. Others visiting the site would know, either by seeing the ‘activated’ icon or by visiting a list of all such ‘activated’ items, that the user has such an interest. A Wishlist is often used on shopping sites to identify items that might be purchased as a gift for the person on whose account Wishlist the item had been ‘activated.’

In an exemplary embodiment of the enhanced wishlist feature, called by the coined name “iftWish” herein, an inactive icon is presented to users, perhaps in the form of an outlined heart (See FIG. 14F). This heart may be ‘activated’ by a touch or mouse click on the icon. This would trigger the following occurrences: The icon color would fill in, displaying that it had been activated, and a numeral would appear in the center of the icon. This numeral would be the mid-range number of a predetermined scale. For example, 3 is the mid-range numeral between the scale of ‘1’ to ‘5’ and it would appear inside the now activated heart icon.

In addition to the numeral, and again referring to FIG. 14F, two small indicators may appear adjacent to, and optionally on either side of the icon. These indicators could be ‘up’ and ‘down’ arrows or ‘+’ and ‘−’ symbols. By clicking on either of these indicators, the user could advance or lower the number inside the icon, changing its ranking within the scale. For example: clicking or tapping the ‘+’ twice would raise the numeral ‘3’ to ‘4’ and then ‘5’. Then, clicking or tapping the ‘minus’ or down arrow would lower the number from ‘5’ down to ‘1’. An alternative method of adjusting within the scale could be what is known to those skilled in the art as a slide bar.

The purpose of these numbers, and the ability to adjust them, is so as to allow the user to not only indicate a general ‘like’ or ‘desire for’ or ‘interest in’ the site content the icon is linked to, but to allow the user to also indicate a degree of intensity related to that general ‘like’ or ‘desire for’ or ‘interest in’. This would allow people or systems viewing and/or tabulating the user's ‘likes’ to gauge the intensity of that ‘like’ and to contrast or prioritize all the individual items placed on the iftWish list based on that intensity.

De-activating the iftWish icon might be accomplished in one of at least two ways, either clicking or tapping the center of the icon or lowering the numeric range to one click below the numeral ‘1’.

A similar adjustable-graphical approach may used in applications where the thumbs up and down method of displaying likes and dislikes is desired. Firstly, color coding can facilitate the identification of positive and negative orientation, particularly if a neutral, ‘closed fist’ status is desired. ‘Degree’ functionality can also be implemented via the inclusion of adjacent control up/down arrows or +/− signs on either side of the up and/or down oriented closed fists and the superimposition of numbers on the body of the hand as the icon is repeatedly clicked. Additionally, the degree of like/dislike can also be depicted by the extension of additional fingers to join the up or down oriented thumb each time the control is clicked. If adjacent control buttons are not desired, continuous clicks on the icon itself can cycle the ‘degree’ from 0 to 5 and then from 5 to 0., zero being denoted by a closed fist. FIG. 14Q shows the complete ‘font’ of twelve possible pictograms. These incorporate the full complement of possible optional elements, none of which are absolutely necessary in order to communicate the same information as delivered by just the hand and fingers.

“No Sho” or Hide Icon Feature. A user who desires to ensure that certain content is not even considered by potential gift givers perusing the web site so as to determine interest in or desire for some particular content would have the capability of inhibiting display of that content during perusals. This could be accomplished by activation of the feature by touch or cursor mouse click on an icon or graphic. For example, in FIG. 14F, a trash can icon is displayed adjacent to the text “hide it.” Once activated, the icon and the item display itself disappear from view, thus making it impossible to suggest as a gift. Alternatively the item could be selected and set by the user within the control preference files, which would maintain a list of all items so activated and allow for their deactivation. The system could factor in this item rejection when determining additional, future gift suggestions. A work-around may be added to the system whereby, should the item be specifically requested in the keyword search box by a user, the item would show in one of the item display windows, but the ‘trashcan’ icon would remain illuminated so the viewer remains aware that the item was a “No Sho” item. A list of all ‘hidden’ items may be maintained in the system's user personal profile, accessed from within the control center, where the user could change his mind and allow the item to be revealed by clicking on it. FIG. 14Q is an exemplary web page illustrating such a list. On this page the option is also afforded the user to additionally hide all similar items. When this option is implemented, all items in the category may be included individually on the list, where they may be ‘cherry-picked’ for continued banishment or reinstated. This, in sum, is an excellent tool for use by people who desire to handpick, edit and curate, the pool of possible gift suggestions.

IftClique feature. An iftClique consists of all those individuals about whom a user has provided input by answering questions and/or those individuals the user sent gifts to as well as vice versa, I.e. those who gifted and/or inputted about the user. FIG. 14H illustrates an exemplary web page for the iftClique feature. Each clique member imbues his fellow members with the strength or weakness of the size of his personal clique and their cumulative scores.

iftClique List. The iftGift website may provide a listing of all the individuals who have sent gifts and answered questions about a person, as well as the interpersonal status of the person's gifting and question answering, i.e. of the two parties, who was the last to engage in the activity. In addition, if the information is afforded the system through various data release permissions, the list may also show those individuals with whom the account holder has established relations through various social media sites but with whom there has been no gift-giving/question answering interaction on the iftGift website. This may make it easier for a member account holder to identify friends they have overlooked and prompt them to initiate such interactions.

iftClique Count Them Out Feature. The iftClique list described above enables the implementation of an additional feature, the ability to “Count Them Out.” By selecting a checkbox associated with each individual name within the clique (FIG. 14H), member account holders would be able to instruct the system not to include that person's specific input into the tabulations of the recommendation engine algorithm. While that particular friend's activities on the site would function as any other friends would as regards to earning points, the exclusion of their responses in the tabulation would take place in the background and remain unknown to them.

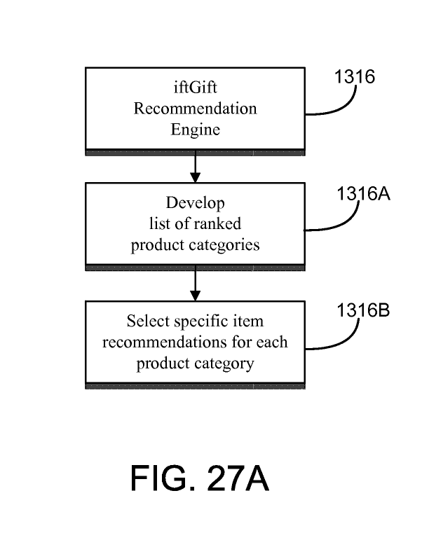

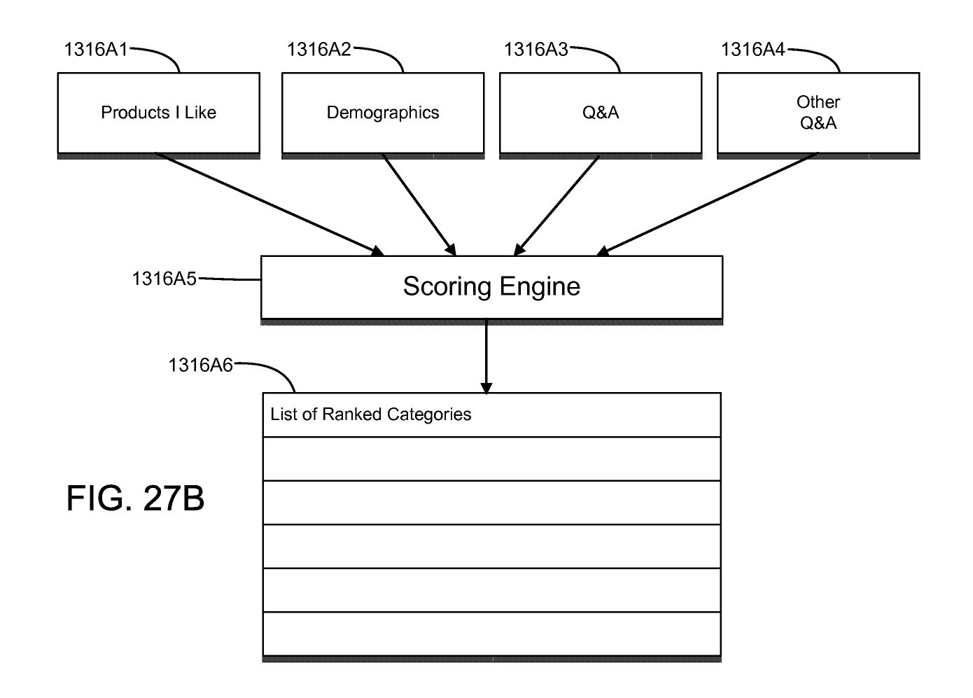

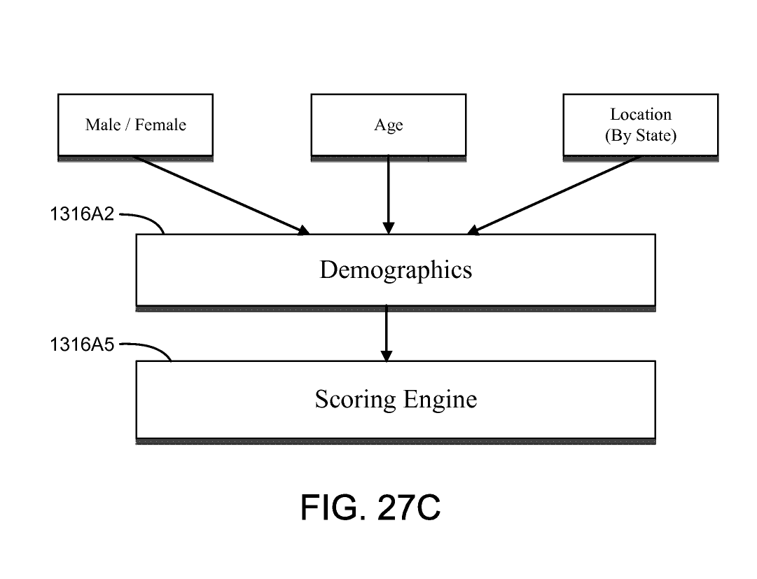

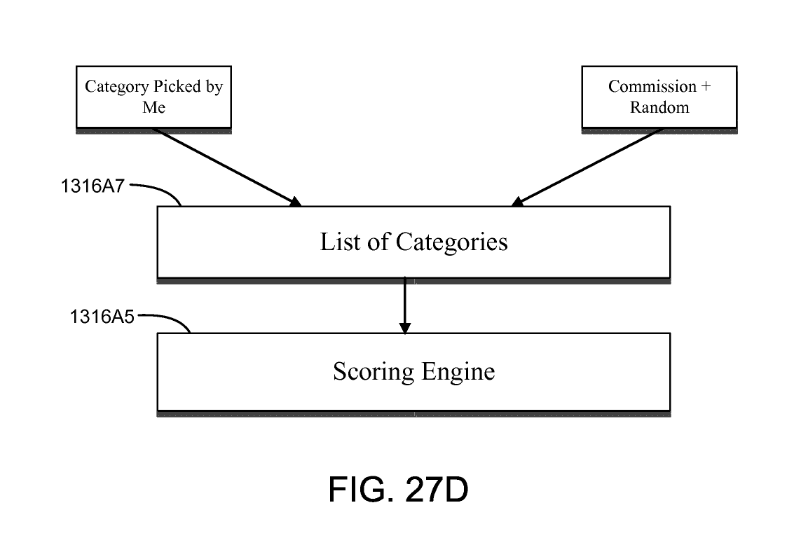

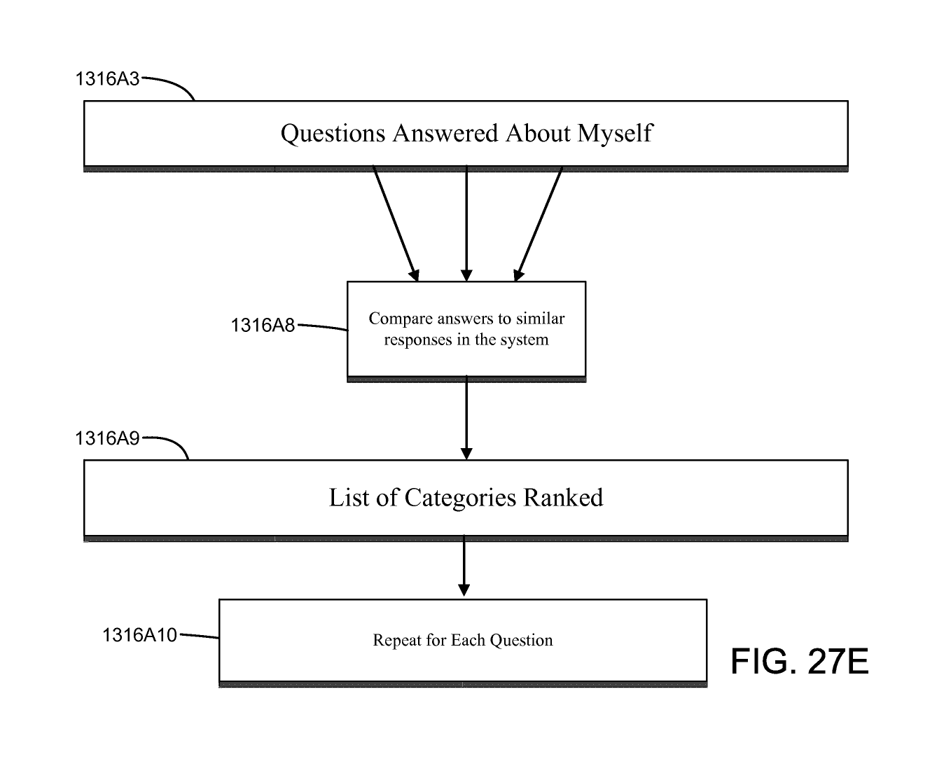

As indicated above, the recommendation engine 1316 (FIG. 14A) may be implemented in different ways. One exemplary embodiment of a recommendation engine is illustrated in FIGS. 27A-27E. In this implementation, the recommendation engine 1316 is implemented by a processor, and includes two modules, a first module 1316A that deals with the prioritization of gift group categories displayed to the user within the six selection windows (FIG. 14F), and a second module 1316B which prioritizes the specific items proffered within the category window. It is expected that category specific recommendations can be gathered quickly from the first use of the site. Item specific recommendations may be limited for some time until a significant database is gathered. Thus, focusing on categories rather than individual items will accelerate system efficiency. Numerous tools and methodologies which can facilitate more detailed selection on the part of users have been discussed above.

In the exemplary embodiment, the recommendation engine may present gift categories to the user based on the weighting of primary consideration classes. In turn, within each of these classes, there may be additional factors forming a weighting value system that impacts both the overall gift categories as well as the individual items.

When choosing gift categories, each consideration module may work independently of the other, and the results weighted together. In this embodiment, there are four consideration classes (1316A1, 1316A2, 1316A3 and 1316A4) for choosing gift categories, as illustrated in FIG. 27B, and described more fully below.

Demographics (1316A2)—The demographics data gathered for almost every gift recipient includes age, sex, and location and these are stored in a database. The system will consider these demographic factors in order to quantify the popularity of various categories in their age, sex and location groups (FIG. 27C). The system will produce a list of gift categories ranked in order of most popular among the demographic groups and return a ranking figure for consideration by the overall engine to factor into its recommendation calculations.

Items On The Recipient's iftWish List (1316A1)—This considers only those categories that have items previously chosen by the recipient for inclusion in the recipient's iftWish list. The system will prioritize these items based on the numeric rank ascribed, i.e. scored 1-5 (FIG. 27D).

Questions Others Answered About Me (the recipient) (1316A4)—The system prompts users to answer questions about others, e.g. the iftPut quiz. The system stores the answers in a database and correlates those specific answers (FIG. 27E, 1316A8) to gift recommendations and purchases made by others about whom the same answers were provided. Each question and answer set is considered separately (1316A) and then averaged together with the other answer and questions sets provided about this individual (1316A10).

Question Answered By Me (the recipient) (1316A4)—These question/answer sets are handled in much the same way, but are kept segregated from sets provided by others.

The four separate data streams described above will be weighted and then averaged. In the absence of empirical data, such as early in the life of the site, random item recommendations, aided by general popularity rankings available from vendors and other sites, may play a greater role in priming the ‘pump’ until a growing databank allows the engine to rely less or not at all on these sources. The results will be a Master Ranking List, produced by the first module 1316A.

In an exemplary embodiment, the second module 1316B of the recommendation engine 1316 functions to prioritize the specific items and their order of appearance within the category windows on the selection page (FIG. 14F). To determine this order in an exemplary embodiment, factors including price, presence on the various iftWish, Already Owned (FIG. 14R) and Hidden lists may be weighed and averaged, as well as the amount of compensation the vendor provides. Of course, in other embodiments, other factors and weighting may be employed.

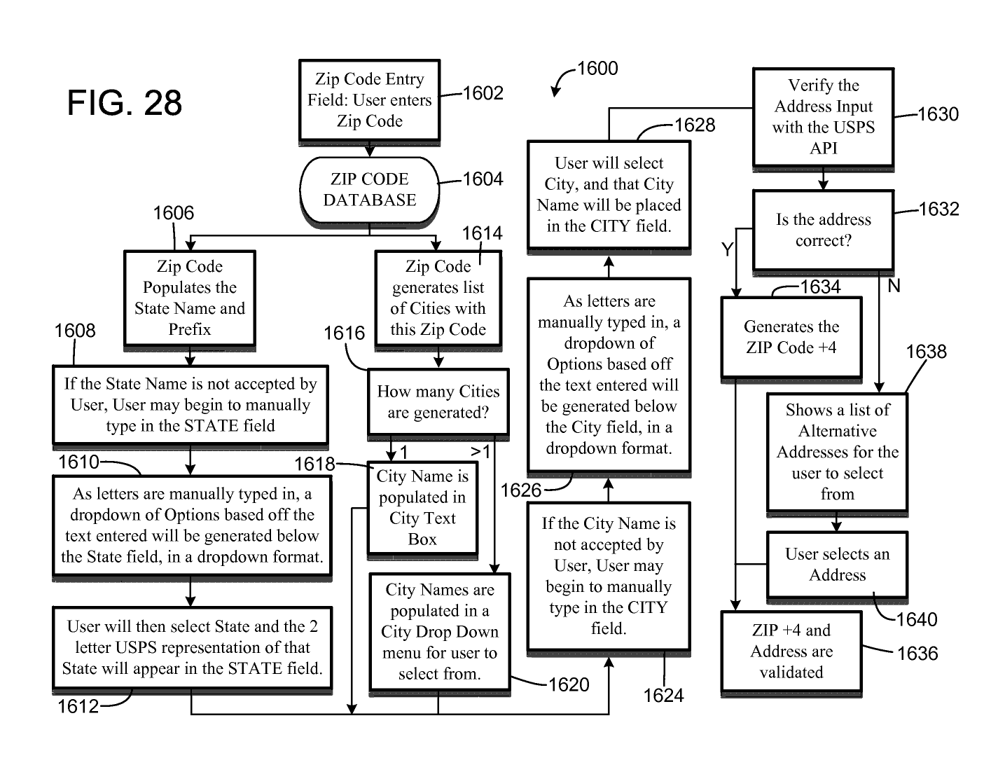

Intuitive Address Input Process Feature. Numerous databases exist for linking street addresses, city names and state names with zip codes. Yet to the applicant's knowledge no website has maximally exploited this available data link to users' benefit. By arranging the data entry to first identify the zip code, as in step 1602 of the flow diagram of FIG. 28, the system and method 1600 could, using a zip code database 1604, automatically enter the fields for state and city (1606, 1614), with a manual override (1608,1612) allowed should the user choose to change them for any reason. Thus the user's data entry process is quicker, easier and more accurate as the possibility of accidental typos and misspellings are minimized if not eliminated. Additionally, if a user is unfamiliar with the two letter postal designation for any individual state, the system will automatically place it in the state text entry field, while the full spelling would be placed in the drop down window beneath (1610), with the system intuitively anticipating the user desired entry.

In cases in which only one city is associated with the zip code cases (1614, 1616), the city name is populated in the city text box (1618). In cases where more than one city name is associated with a particular zip code, the possible choices would be displayed (1620) in dropdown boxes under the city name text entry field and the user could select the appropriate choice with a click. The system will also be programmed to default to the most popular/probable city name among the possible choices if a manual change is not made by the user.

If a user begins to manually enter a state or city name (1624), the system will assume that the choices provided therein are neither acceptable nor accurate and that an error was made in the entry of the zip code, and data entry into the field would be temporarily disabled. Therefore, the zip code would be removed from the zip code field. As the user begins to type into the State field (1608), the system would adaptively assist in arriving at the complete intended entry. The system will anticipate and forestall many common mistakes by requiring two sequential characters, rather than one, to be ‘wrong’ before it eliminates that choice as an option. For example, as the user types an ‘N’ into the state field, the dropdowns would offer the choices of: Nebraska, Nevada, New Hampshire, New Jersey, New Mexico, New York, North Carolina, North Dakota. Upon entry of ‘NE,’ North Carolina and North Dakota would not yet be eliminated from the drop down list. However, when ‘NEW’ is entered, the “w” is added, the system would automatically drop the North Carolina and North Dakota options, and re-order the option list as New Hampshire, New Jersey, New Mexico, New York, Nebraska, Nevada. While the last two choices are likely not to be desired or viable, because they do not contain a “w”, they remain in sight because the “w” may have been a typo. Then, upon entry of a ‘space’ after the ‘w’, the system would drop Nebraska and Nevada as options as well. In all cases, it is possible that, while the state designation is fully spelled out in the drop down windows, only the two character USPS designation appears in the entry field, despite the fact that the entry cursor is moving along within that field.

Once the state is identified and approved (1612), a user will start to manually enter a city name (1624). Much like as described above, the system will draw upon a database of cities in the selected state, but will not offer dropdown choices until enough characters have been manually entered so that the number of dropdown choices will not exceed ten (1626). Should a number of cities in a particular state share the exact same name, a pop up window would suggest that the user seek other means to determine the correct zip code, at which time they may avail themselves of this intuitive entry process.

Once the state and city are determined (1612, 1628), the system can then verify the address input from a USPS database (1630), and if the address is correct (1632), generate (1634) the USPS' +4 enhanced zip code and place it into the zip code field, the zip code and address having been validated (1636). If there was something inaccurate about the street name or number, the system will cause drop down boxes with the most likely alternatives to be displayed (1638), e.g. nearest registered odd or even number; variations of spelling, East, North, etc. signifiers and Street, Boulevard, Avenue, etc., designations. The user could select from the choices given or would be able to manually correct these fields as well (1640). Then, a press of a submit button would approve and complete the entry (1636).

Although limited embodiments of the method and system for making financial gifts have been specifically described and illustrated herein, many modifications and variations will be apparent to those skilled in the art, such as modifying the order of steps, or deleting or adding steps. Accordingly, it is to be understood that the method and system for making financial gifts and for generating a psychographic profile of an individual according to principles of this invention may be embodied other than as specifically described herein. Further, the features described herein have utility for applications other than methods and systems for making financial gifts or generating psychographic profiles. Such features include, for example, the “rank and rate” and “U&I” question formats (e.g. FIGS. 18 and 19), the “Reality Check” feature, the “iftWish” feature in which the degree of the person's interest in an item is stored and available for display and utilization (FIG. 14F, FIG. 14R), the intuitive zip code address method (FIG. 28), the “No Sho” or “Hide Icon” feature (FIG. 14Q), the “Count Them Out” feature (FIG. 14H), and the “Re:Guards” feature (FIG. 14G),

What is claimed is:

1. A computer-implemented method for electronic gift giving, the method comprising a sequence of the following steps:
(a) providing an internet site for access by a first giver via a first giver device;
(b) prompting the first giver to enter giver identification information and associating the giver information with a giver account;
(c) storing the first giver identification information in a data store;
(d) prompting the first giver to enter first recipient information defining a first recipient;
(e) allowing the first giver to elect to provide profile input data in the form of a subjective assessment of what the appropriate answers are relative to the first recipient to a set of questions to provide profile input data to establish or update a first recipient profile of the first recipient, said set of questions including questions seeking psychographic data about the first recipient, said first recipient profile stored in a recipient profile data store;
(f) prompting the first giver to enter a value of a monetary gift;
(g) using the first recipient profile to recommend at least one gift or transfer of funds that may be obtained using the monetary gift, wherein the recommended at least one gift or transfer of funds is based on the first recipient profile.

2. The method of claim 1, further comprising:
electronically transferring the value of the monetary gift to a gift account of the recipient.

3. The method of claim 1, further comprising:
allowing a second giver to access the Internet site via another giver device;
prompting the second giver to enter recipient information;
if the recipient information identifies the first recipient,
allowing the second giver to elect to provide profile input data in the form of a subjective assessment of what the appropriate answers are relative to the first recipient to said set of questions to update the first recipient profile, and updating said first recipient profile with the profile input data provided by the second giver; and
allowing the second giver to recommend at least one gift or transfer of funds, wherein the recommended at least one gift or transfer of funds is based on the updated first recipient profile.

4. The method of claim 1, further comprising:
allowing the first recipient to access the Internet site via a first recipient device;
prompting the first recipient to enter recipient information;
if the recipient information identifies the first recipient,
allowing the first recipient to elect to provide first recipient profile input data in the form of a subjective assessment of what the appropriate answers are relative to the first recipient to said set of questions; and
storing the first recipient profile input data in the data store.

5. The method of claim 4, further comprising:
comparing said first recipient profile input data to said data in said first recipient profile; and
generating comparison data for display of a result of said comparing on a device to indicate how the first recipient responses to said set of questions compares to responses to said questions about said first recipient received from said first giver or other persons.

6. The method of claim 5, further comprising:
calculating a score indicative of said result.

7. The method of claim 1, wherein responses to said set of questions take the form of at least one of multiple choice, a selection within a range, comparison between the first giver and the recipient, and a ranking of an activity.

8. The method of claim 1, wherein the Internet site is accessible to other givers or responders via other giver or responder devices to respond to said set of questions to update the first recipient profile input data of the first recipient.

9. The method of claim 1, further comprising:
prompting the first giver to enter gift giver/recipient specific information known only to the first gift giver and the first recipient;
sending an electronic message to the first recipient to notify the first recipient of the at least one gift or transfer of funds, the electronic message including a subject line with the gift giver/recipient specific information.

10. A computer-implemented method for generating a psychographic profile of an individual person, the method comprising:
(a) providing an Internet site for access by a first participant-profiler via a first device;
(b) prompting the first participant-profiler to enter participant identification information and associating the participant information with a first participant-profiler account;
(c) prompting the first participant-profiler to enter information defining an individual person;
(d) storing the information defining said individual person in a data store;
(e) prompting the first participant-profiler to provide profile input data in the form of a subjective assessment of appropriate answers relative to the individual person to a set of questions to provide profile input data to establish or update a data profile of the individual person, said set of questions including questions seeking physically descriptive and subjective psychographic perception data about the first recipient, said data profile stored in a profile data store;
(f) repeating steps a)-e) for a second and subsequent participant-profilers to update said psychographic profile for said individual person.

11. The method of claim 10, further comprising:
allowing said individual person to access said internet site via an individual device;
prompting said individual person to provide profile input data in the form of a subjective assessment of appropriate answers relative to the individual person to said set of questions to establish or update a second self-perception data profile of the individual person;
generating a data comparison between said data profile and said second data profile to demonstrate how self-perception data of the individual person match perception data entered by said participant profilers.

12. The method of claim 10, wherein responses to said set of questions take the form of at least one of multiple choice, a selection within a range, comparison between two different persons, and a ranking of an activity.

13. A server for a gift giving system, the server comprising:
a processor; and
a memory operably coupled to the processor storing program instructions therein, the processor being operable to execute the program instructions;
the program instructions comprising:
(a) providing an Internet site for access by a first giver via a first giver device;
(b) prompting the first giver to enter giver identification information and associating the giver information with a giver account;
(c) storing the first giver identification information in a data store;
(d) prompting the first giver to enter first recipient information defining a first recipient;
(e) allowing the first giver to elect to provide profile input data in the form of a subjective assessment of what the appropriate answers are relative to the first recipient to a set of questions to provide profile input data to establish or update a first recipient profile of the first recipient, said set of questions including questions seeking psychographic data about the first recipient relating to personality, attitudes, behavioral characteristics, interests, cultural and lifestyle factors or variables, said first recipient profile stored in a recipient profile data store;
(f) prompting the first giver to enter a value of a monetary gift;
(g) using the first recipient profile to recommend at least one gift or transfer of funds that may be obtained using the monetary gift, wherein the recommended at least one gift or transfer of funds is based on the first recipient profile.

14. The server of claim 13, wherein said instructions further comprise:
allowing a second person to access the Internet site via another giver device;
prompting the second person to enter recipient information;
if the recipient information identifies the first recipient,
allowing the second person to provide profile input data in the form of a subjective assessment of what the appropriate answers are relative to the first recipient to said set of questions to update the first recipient profile, and updating said first recipient profile with the profile input data provided by the second person; and
storing the updated first recipient profile in the data store.

15. The server of claim 13, wherein the instructions further comprise:
allowing the first recipient to access the Internet site via another device;
prompting the first recipient to enter recipient information;
if the recipient information identifies the first recipient,
allowing the first recipient to elect to provide first recipient profile input data in the form of a subjective assessment of what the appropriate answers are relative to the first recipient to said set of questions; and
storing the first recipient profile input data in the data store.

16. The server of claim 15, wherein the instructions further comprise:
comparing said first recipient profile input data to said updated first recipient profile; and
generating comparison data for display of said comparison data on a device to indicate how the first recipient responses to said set of questions compares to responses to said questions about said first recipient received from said first person and said second person and other responders.

17. The server of claim 16, wherein the instructions further comprise:
calculating a score indicative of said result.

18. The server of claim 13, wherein responses to said set of questions take the form of at least one of multiple choice, a selection within a range, comparison between two different persons, and a ranking of an activity.

19. The server of claim 13, wherein the Internet site is accessible to other givers or responders via other giver or responder devices to respond to said set of questions to update the first recipient profile input data of the first recipient.

20. The server of claim 13, wherein the instructions further comprise:
prompting the first giver to enter gift giver/recipient specific information known only to the first gift giver and the first recipient;
sending an electronic message to the first recipient to notify the first recipient of the at least one gift or transfer of funds, the electronic message including a subject line with the gift giver/recipient specific information.

21. A computer-implemented gift giving system comprising:
an Internet interface;
a giver account database accessed through the Internet interface by a giver and storing giver information;
a recipient account database accessed through the Internet interface by the giver and storing recipient information including psychographic data about the recipient relating to personality, attitudes, behavioral characteristics, interests, cultural and lifestyle factors or variables, said psychographic data including data collected from persons acquainted with the recipient, and a monetary value of a gift; and
a processor coupled to the giver account and the recipient account, the processor configured to execute programming instructions to implement a recommendation engine for recommending gift suggestions based at least in part on said recipient information and the monetary value of the gift, and to create an electronic gift comprising a set of gift suggestions, and to deliver the electronic gift to a recipient over the Internet interface.

22. The system of claim 21 wherein the recipient database includes a list of one or more gift items the recipient has chosen to exclude from selection by the recommendation engine.

23. The system of claim 21, wherein the recipient database includes a list of items of interest to the recipient, and said list further includes a data item indicative of the degree of interest in each item of interest to indicate the intensity of the recipient's interest, and the processor is configured to display to a giver the indicated degree of interest for a suggested item.

24. The system of claim 21, wherein the recipient database includes a list of said persons acquainted with the recipient from whom said data has been collected about the recipient and whom the recipient has designated as persons whose input data is not to be considered by the recommendation engine in suggesting a gift for the recipient.

25. The system of claim 21, wherein the Internet interface includes a data entry system for entering a recipient's address, the data entry system configured to first prompt entry of a zip code by a user, to automatically enter the fields for state and city from a zip code data base, with subsequent entry of address information, and to allow a manual override if the user chooses to change the state and city for any reason, the manual override including removing the previously entered zip code, manually entering state information, then city information, then address information, and subsequent entry of a corresponding zip code.

26. The system of claim 21, wherein the Internet interface is configured to allow a person-responder to enter responses to a set of questions regarding the recipient, said set of questions including questions seeking physically descriptive and psychographic data about the recipient relating to the person-responder's perceptions of personality, behavioral characteristics, interests, cultural and lifestyle factors or variables of the recipient.

27. The system of claim 26, further comprising a library of questions to elicit psychographic information, and the set of questions is selected from said library.

28. The system of claim 21, wherein the processor is further configured to accumulate earned points for the recipient in the recipient database, the points earned for actions undertaken on the interface regarding the recipient, including collection of data from persons acquainted with the recipient.

29. The system of claim 28, wherein the recommendation engine is configured to take into account the point accumulation, the point accumulation allowing a user embarking on a gifting session about a recipient to ascertain a caliber of input data upon which the recommendation engine bases its gift suggestions regarding the recipient.

30. The system of claim 21, wherein the processor is configured to:
aggregate profile data input about an individual recipient from all respondents, including optionally the recipient, and to create or update a recipient profile including psychographic and demographical profile input data;
allow a giver to select and transmit a number of the product or service recommendations generated by the recommendation engine to the recipient; and
transfer funds electronically to a recipient account.

31. A computer-implemented method for providing a response to a question, comprising:
(a) providing an Internet site for access by a respondent via a respondent device;
(b) posing one or more questions to the respondent which call upon the respondent to draw comparisons between one individual or item or activity or topic or attitudes or attributes and another individual or item or activity or topic;
(c) presenting the respondent with two columns or bars, one marked with one individual or item or activity or topic or attitudes or attributes and the other column or bar representing another individual item or activity or topic or attitudes or attributes;
(d) allowing the respondent to present a response to the question for the first individual or item or activity or topic or attitudes or attributes and for the another individual, item or activity or topic or attitudes or attributes by adjusting the two columns relative to each other.

32. A computer-implemented method for providing a response to a question, comprising:
(a) providing an Internet interface for access by a respondent via a respondent device;
(b) presenting one or more questions involving an item or activity or topic or attitudes or attributes to the respondent regarding a subject individual, with a number of potential answers presented as a title, an icon, a photo or contained as a written word in separate graphical images;
(c) allowing the user to drag and drop any or all of the answer elements onto a series of columns or bars organized along an axis in preferred order for the item or activity or topic or attitudes or attributes, and to adjust a visual metric for each column or bar providing a rating to indicate how much time or an interest level the subject individual spends or has with the subject item or activity or topic for each column or bar.

33. A computer-implemented method for indicating a degree of interest in an item in a stored wish list for a person, comprising:
(a) providing an Internet site for access by the person via a first device;
(b) prompting the person to establish a wish list of desired items or activities or topics or attitudes or attributes;
(c) associated with each item a data item indicated a level of interest or disinterest of the person in the item, covering a range of interest or disinterest levels;
(d) displaying a wish list item icon having an indication of said level of interest or disinterest.

34. A method of electronic messaging, to enhancing the comfort level of a message recipient receiving an unexpected email message from a message sender, comprising:
preparing an email message with a subject line;
addressing the email message to a recipient;
inserting into the subject line a message containing personal shared information known only to the message sender and the recipient.

35. A method for intuitive address data input to a computer system interface, comprising:
arranging the data entry for address information to first enter a zip code,
using a zip code database to automatically enter fields for state and city;
allowing a manual override if a user chooses to change the state or city fields, by deleting the entering zip code, and allowing the user to manually enter the state and then the city;
requiring two character keystrokes to be entered before the system attempts to determine the intended data entry;
automatically place a two letter postal designation in the state entry field, with a full spelling placed in a drop down window beneath the two letter designation;
entering a street or box address and a zip code.
